(19) United States
(12) Patent Application Publication
(10) Pub. No.: US 2006/0076482 A1
(43) Pub. Date: Apr. 13, 2006

(54) High throughput systems and methods for parallel sample analysis

(76) Inventors: Steven E. Hobbs, Pleasanton, CA (US); Stephen D. O'Connor, Pasadena, CA (US); Ronald C. Gamble, Altadena, CA (US)

Correspondence Address: NANOSTREAM, INC.;C/O INTELLECTUAL PROPERTY/TECHNOLOGY LAW, PO BOX 14329, RESEARCH TRIANGLE PARK, NC, 27709, US

(21) Appl. No.: 11/273,064

(22) Filed: Nov. 14, 2005

Related U.S. Application Data
(63) Continuation-in-part of application No. 10/736,154, filed on Dec. 13, 2003, now Pat. No. 6,987,263.
(60) Provisional application No. 60/433,449, filed on Dec. 13, 2002.

(30) Foreign Application Priority Data
Jul. 23, 2004 (WO) PCT/US04/23980

(51) Int. Cl. H01J 49/00

(52) U.S. Cl. 250/287

(57) ABSTRACT

Systems and methods for analyzing multiple samples in parallel using mass spectrometry preferably coupled with fluid phase separation techniques are provided. A modular mass spectrometer includes a vacuum enclosure, multiple sample inlets, multiple common vacuum pumping elements, and multiple mass analysis modules disposed substantially within the enclosure, with each module preferably including a mass analyzer and a transducer. In one embodiment, the modules mate with the vacuum enclosure to define multiple sequential vacuum regions, with each vacuum region having an associated common vacuum pumping element. At least one multi-pole ion transfer optic element is preferably associated with each module. Fluid phase separation devices may include microfluidic devices utilizing chromatographic, electrophoretic, or other separation methods.

### STATEMENT OF RELATED APPLICATIONS

This application is a continuation-in-part of U.S. patent application Ser. No. 10,736,154 filed Dec. 13, 2003 (allowed); claims benefit of WIPO International Application No. PCT/US2004/023980 filed Jul. 23, 2004; and claims benefit of U.S. Provisional Patent Application Ser. No. 60/433,449 filed Dec. 13, 2002.

### FIELD OF THE INVENTION

The present invention relates to systems and methods for analyzing multiple samples in parallel using mass spectrometric and/or fluid phase separation techniques.

### DESCRIPTION OF THE RELATED ART

Recent developments in the pharmaceutical industry and in combinatorial chemistry have exponentially increased the number of potentially useful compounds, each of which must be characterized in order to identify their active components and/or establish processes for their synthesis. To more quickly analyze these compounds, researchers have sought to automate analytical processes and to implement analytical processes in parallel.

Various chemical and biochemical fluid phase separation processes are known, including chromatographic, electrophoretic, electrochromatographic, immunoaffinity, gel filtration, and density gradient separation. Each of these processes is capable of separating species in fluid samples with varying degrees of efficiency to promote their analysis.

One particularly useful fluid phase separation process is chromatography, which may be used with a wide variety of sample types and encompasses a number of methods that are used for separating ions or molecules that are dissolved in or otherwise mixed into a solvent. Liquid chromatography (“LC”) is a physical method of separation wherein a liquid “mobile phase” (typically consisting of one or more solvents) carries a sample containing multiple constituents or species through a separation medium or “stationary phase.” Various types of mobile phases and stationary phases may be used. Stationary phase material typically includes a liquid-permeable medium such as packed granules (particulate material) disposed within a tube (or other channel boundary). The packed material contained by the tube or similar boundary is commonly referred to as a “separation column.” High pressure is often used to obtain a close-packed column with a minimal void between each particle, since better resolution during use is typically obtained from more tightly packed columns. As an alternative to packed particulate material, a porous monolith or similar matrix may be used. So-called “high performance liquid chromatography” (“HPLC”) refers to efficient separation methods that are typically performed at high operating pressures.

Typical interactions between stationary phases and solutes include adsorption, ion-exchange, partitioning, and size exclusion. Examples of types of stationary phases to support such interactions are solids, ionic groups on a resin, liquids on an inert solid support, and porous or semi-porous inert particles, respectively. Commonly employed base materials include silica, alumina, zirconium, or polymeric materials. A stationary phase material may act as a sieve to perform simple size exclusion chromatography, or the stationary phase may include functional groups (e.g., chemical groups) to perform other (e.g., adsorption or ion exchange separation) techniques.

Mobile phase is forced through the stationary phase using means such as, for example, one or more pumps, gravity, voltage-driven electrokinetic flow, or other established means for generating a pressure differential. After sample is injected into the mobile phase, such as with a conventional loop valve, components of the sample will migrate according to interactions with the stationary phase and the flow of such components are retarded to varying degrees. Individual sample components may reside for some time in the stationary phase (where their velocity is essentially zero) until conditions (e.g., a change in solvent concentration) permit a component to emerge from the column with the mobile phase. In other words, as the sample travels through voids or pores in the stationary phase, the sample may be separated into its constituent species due to the attraction of the species to the stationary phase. The time a particular constituent spends in the stationary phase relative to the fraction of time it spends in the mobile phase will determine its velocity through the column. Following separation in an LC column, the eluate stream contains a series of regions having an elevated concentration of individual component species. Thus, HPLC acts to provide relatively pure and discrete samples of each of the components of a compound. Gradient separations using conventional HPLC systems are typically performed within intervals of roughly five to ten minutes, followed by a flush or rinse cycle before another sample is separated in the same separation column.

Following chromatographic separation in a column (or other fluid phase separation), the resulting eluate (or effluent) stream contains a series of regions having elevated concentrations of individual species, which can be detected by various flow-through techniques including spectrophotometric (e.g., UV-Visible absorption), fluorimetric, refractive index, electrochemical, or radioactivity detection. Fluid phase separation with flow-through detection generally provides signal response that is proportional to analyte amount or concentration. As a result, fluid phase separations are often well-suited for quantitative analyses, but less suited for identifying or characterizing individual components—particularly when novel or previously uncharacterized compounds are used.

To provide increased throughput, parallel fluid phase separation systems including multi-column LC separation systems and multi-channel electrophoretic separation systems have been developed.

Another important analytical technique that can complement fluid phase separation is mass spectrometry (“MS”), a process that analyzes ions utilizing electromagnetic fields. More specifically, MS permits molecular mass to be measured by determining the mass-to-charge ratio (“m/z”) of ions generated from target molecules. MS is a fast analytical technique that typically provides an output spectrum displaying ion intensity as a function of m/z. One benefit of using MS is that it can provide unique information about the chemical composition of the analyte—information that is much more specific than can be obtained using flow-through detection technology typically employed with most fluid phase separation processes. The ability to qualitatively identify molecules using MS complements the quantitative capabilities of fluid phase separations, thus providing a second dimension to the analysis.

A system for performing mass spectrometry typically includes an ionization source that generates ions from a sample and delivers them into the gas phase, one or more focusing elements that facilitate ion travel in a specific direction, an analyzer for separating and sorting the ions, and a transducer or detector for sensing the ions as they are sorted and providing an output signal. Since a mass spectrometer requires compounds to be in the gas phase, vacuum pumping means and a vacuum enclosure surrounding at least the focusing elements and analyzer are provided. Multiple vacuum stages are typically provided.

Various mass spectrometric techniques are known, including time-of-flight (“TOF”), quadrupole, and ion trap. In a TOF analyzer, ions are separated by differences in their velocities as they move in a straight path toward a collector in order of increasing mass-to-charge ratio. In a TOF MS, ions of a like charge are simultaneously emitted from the source with the same initial kinetic energy. Those with a lower mass will have a higher velocity and reach the transducer earlier than ions with a higher mass. In a quadrupole device, a quadrupolar electrical field (comprising radiofrequency and direct-current components) is used to separate ions. An ion trap (e.g., quadrupole-based) can trap ions and separate ions based on their mass-to-charge ratio using a three-dimensional quadrupolar radio frequency electric field. In ion trap instruments, ions of increasing mass-to-charge ratio successively become unstable as the radio frequency voltage is scanned.

Various conventional ionization techniques may be used with mass spectrometry systems to yield positively or negatively charged ions. One prevalent technique is electrospray ionization (ESI), which is a “soft” ionization technique. That is, ESI does not rely on extremely high temperatures or extremely high voltages to accomplish ionization, which is advantageous for the analysis of large, complex molecules that tend to decompose under harsh conditions. In ESI, highly charged droplets of analyte dispersed from a capillary in an electric field are evaporated, and the resulting ions are drawn into a MS inlet. Other known ionization techniques include: chemical ionization (which ionizes volatilized molecules by reaction with reagent gas ions); field ionization (which produces ions by subjecting a sample to a strong electric field gradient); spark-source desorption (which uses electrical discharges or sparks to desorb ions from samples); laser desorption (which uses a photon beam to desorb sample molecules); matrix-assisted laser desorption ionization or “MALDI” (which produces ions by laser desorbing sample molecules from a solid or liquid matrix containing a highly UV-absorbing substance); fast atom bombardment or “FAB” (which uses beams of neutral atoms to ionize compounds from the surface of a liquid matrix); and plasma desorption (which uses very high-energy ions to desorb and ionize molecules in solid-film samples).

By coupling the outputs of one or more fluid phase separation process regions to a MS instrument, it becomes possible to both quantify and identify the components of a sample. There exist challenges, however, in providing efficient integrated fluid phase separation/MS systems. MS instruments are typically extremely complex and expensive to operate and maintain, due primarily to the need to precisely control the electromagnetic fields generated within such devices and the need to maintain vacuum conditions therein. Integrated fluid phase separation/MS systems including a single fluid phase process region coupled to a mass spectrometer instrument by way of an ESI interface are known, but they suffer from limited throughput since they can only analyze one sample at a time—and the upstream fluid phase separation process is typically much slower than the downstream mass analysis process. In other words, a fluid phase separation/MS analyzer system having only a single fluid phase separation process region fails to efficiently utilize the rapid analytical capabilities of the MS analyzer portion.

More efficient systems including multiple fluid phase separation process regions coupled to a single MS analyzer are also known and provide higher throughput compared to systems having only a single fluid phase separation process region, but these improved systems still suffer from limited utility. Examples are provided in U.S. Pat. No. 6,410,915 to Bateman, et al.; U.S. Pat. No. 6,191,418 to Hindsgaul, et al.; U.S. Pat. No. 6,066,848 to Kassel, et al.; and U.S. Pat. No. 5,872,010 to Karger, et al., each showing some variation of a multiplexed fluid phase (e.g., LC) separation/MS systems where the outputs of multiple simultaneously-operated fluid phase separation regions are periodically sampled by a single MS device. In these multiplexed systems, however, the MS can sample an effluent stream from only one fluid phase separation process region at a time. While one stream is being analyzed, the others must continue to flow, as these systems have no storage capacity. This inherently results in data loss. To mitigate this data loss, MS sampling must occur very quickly. The MS analyzer thus receives very small plugs of sample-containing effluent, reducing the ability of the MS instrument to integrate data in order to eliminate noise and resulting in reduced signal clarity. Additionally, such conventional systems typically utilize mechanical gating for directing desorbed effluent into a single MS inlet. Mechanical gating components limit the scalability and increase the complexity and cost of the resulting system.

Accordingly, there exists a need for improved analytical systems that permit parallel analysis of multiple samples. Advantageous system characteristics would include scalability to permit a large number of samples to be analyzed simultaneously at a relatively low cost per analysis with a minimal loss of data and/or signal clarity. Such a system would preferably employ common system components (e.g., vacuum pumps) for multiple channels, and employ interchangeable channel-specific components where feasible. Ideally, an improved system would be comparatively simple and inexpensive to build, operate, and maintain.

### SUMMARY OF THE INVENTION

The present invention relates to systems and method for analyzing multiple samples in parallel using mass spectrometric techniques, preferably in conjunction with fluid phase separation techniques.

In one embodiment, a multi-channel mass spectrometer includes:
a vacuum enclosure having a plurality of sample inlets;
a plurality of common vacuum pumping elements;
at least one ionization source in fluid communication with the plurality of sample inlets; and
a plurality of modules disposed substantially within the vacuum enclosure and adapted to operate in parallel, each module being in fluid communication with a different sample inlet and having:
   at least one ion transfer optic element; and
   a mass analyzer including a transducer;
wherein the plurality of modules mate with the vacuum enclosure to define a plurality of sequential vacuum regions, with each vacuum region having at least one associated common vacuum pumping element of the plurality of common vacuum pumping elements.

In another embodiment, an analytical system includes a multi-channel mass spectrometer and a plurality of fluid phase separation process regions, wherein each fluid phase separation process region is in fluid communication with the (at least one) ionization source.

In another embodiment, a method for analyzing a plurality of samples in parallel includes multiple method steps, including the steps of:
providing at least one ionization source providing a mass spectrometer having a plurality of modules in fluid communication with the at least one ionization source, each module being disposed within a common enclosure having at least one vacuum region, being adapted to operate in parallel, having an associated ion transfer optic element, and having an associated mass analyzer, the ion transfer optic element being disposed within the at least one vacuum region;
providing a plurality of prepared samples;
ionizing at least a portion of each prepared sample with the at least one ionization source to yield a plurality of gaseous streams, each gaseous stream including an ionized species and a non-ionized species;
directing each gaseous stream of the plurality of gaseous streams into a different module, such that each module has an associated gaseous stream of the plurality of gaseous streams;
for each module, directing at least a portion of the ionized species through the associated ion transfer optic element to the associated mass analyzer; and
for each module, detecting at least a subset of the at least a portion of the ionized species using the associated mass analyzer.

Other aspects, features and embodiments of the invention will be more fully apparent from the ensuing disclosure and appended claims.

### BRIEF DESCRIPTION OF THE DRAWINGS

In the drawings, like numbers are intended to refer to like elements or structures. None of the drawings are drawn to scale unless indicated otherwise.

FIG. 1 is a top view of a twenty-four column microfluidic liquid chromatographic separation device.

FIG. 2A is an exploded perspective view of a first portion, including the first through fourth layers, of the device shown in FIG. 1.

FIG. 2B is an exploded perspective view of a second portion, including the fifth and sixth layers, of the device shown in FIG. 1.

FIG. 2C is an exploded perspective view of a third portion, including the seventh and eighth layers, of the device shown in FIG. 1.

FIG. 2D is an exploded perspective view of a fourth portion, including the ninth through twelfth layers, of the device shown in FIG. 1.

FIG. 2E is a reduced scale composite of FIGS. 2A-2D showing an exploded perspective view of the device of FIG. 1.

FIG. 3 is a schematic showing interconnections between various components of a high throughput analytical system capable of analyzing multiple samples in parallel, the system including a liquid phase separation subsystem, a flow-through detection subsystem, and an ionization and mass analysis subsystem.

FIG. 4 is a simplified diagrammatic view of a high-throughput analytical system including a parallel liquid phase separation apparatus and a multi-channel secondary analysis apparatus.

FIG. 5A is a simplified diagrammatic side view of a portion of the secondary analysis apparatus of FIG. 4 in operation.

FIG. 5B is a simplified diagrammatic side view of a portion of the secondary mass analysis apparatus of FIG. 4 and FIG. 5B.

FIG. 6 is a simplified perspective view of a multi-analyzer mass spectrometer including multiple flight tubes.

FIG. 7A is a simplified diagrammatic side view of an analytical system providing mass analysis utility and including a module.

FIG. 7B is a simplified diagrammatic side view of a first alternative module for use with the system of FIG. 7A.

FIG. 7C is a simplified diagrammatic side view of a second alternative module for use with the system of FIG. 7A.

FIG. 7D is a simplified diagrammatic side view of a third alternative module for use with the system of FIG. 7A.

FIG. 8A is an exploded side cross-sectional view of a modular multi-analyzer mass spectrometer including multiple modules, a chassis, and a vacuum enclosure, the spectrometer adapted to permit parallel analysis of multiple samples.

FIG. 8B is an assembled side cross-sectional view of the mass spectrometer of FIG. 8A.

FIG. 9A is a front diagrammatic view of a mass spectrometer including multiple modules disposed in a one-dimensional array.

FIG. 9B is a front diagrammatic view of a mass spectrometer including multiple modules disposed in a two-dimensional array.

FIG. 10 is a front view of a multi-channel focuser having multiple focusing elements integrated on a common support and having a common edge connector.

FIG. 11 is a simplified diagrammatic side view of a mass analysis module for use with a multi-analyzer modular mass spectrometer.

FIG. 12A is a simplified front cross-sectional view of a mass spectrometer including a first mass spectrometer subassembly having multiple mass analysis channels.

FIG. 12B is a simplified front cross-sectional view of a mass spectrometer including first and second mass spectrometer subassemblies each having multiple mass analysis channels.

FIG. 13 is a simplified front cross-sectional schematic view of multiple flight tubes of a multi-channel time-of-flight mass spectrometer.

FIG. 14A is a simplified front cross-sectional schematic view of a first multi-channel quadrupole mass spectrometer.

FIG. 14B is a simplified front cross-sectional schematic view of a second multi-channel quadrupole mass spectrometer.

FIG. 15A is a top perspective view of a module for a multi-channel mass spectrometer, the module including a time-of-flight mass analyzer.

FIG. 15B is a magnified top perspective view of a portion of the module of FIG. 15A.

FIG. 15C is a top view of the module of FIGS. 15A-15B.

FIG. 16A is a top assembly view of the module of FIGS. 15A-15C prior to insertion into a common enclosure adapted to contain multiple modules, with three upper access panels of the enclosure being omitted.

FIG. 16B is a top view of the module of FIG. 15A-15C inserted into place within the enclosure of FIG. 16A, with the upper wall of the enclosure being omitted for clarity.

FIG. 16C is a front perspective view of the enclosure of FIGS. 16A-16B containing the module of FIGS. 15A-15C, with the upper access panels of the enclosure being omitted.

FIG. 16D is a rear perspective view of the enclosure of FIGS. 16A-16C containing the module of FIGS. 15A-15C, with the rear wall of the enclosure being omitted for clarity.

FIG. 17A is a front perspective view of a hub comprised of a multi-layer printed circuit board, the hub providing conductance limit, pole mechanical support, and electrical conveyance/distribution utility.

FIG. 17B is an assembly view of the hub of FIG. 17A.

FIG. 17C is a front view of a portion of the hub of FIGS. 17A-17B, including the conductance limit and pole capture regions.

FIG. 17D is a front view of the hub of FIGS. 17A-17B.

FIG. 17E is a rear view of the hub of FIGS. 17A-17B.

FIG. 17F is a front view of the hub of FIGS. 17A-17B disposed within an annular supporting rim having an outer O-ring to provide sealing utility, with four longitudinal support members joined to the rim and with multiple poles joined to each outer face of the hub.

FIG. 17G is a side cross-sectional view of the hub, rim, O-ring, longitudinal supports, and poles of FIG. 17F taken along section lines “A”-“A” illustrated in FIG. 17F.

### DETAILED DESCRIPTION OF THE INVENTION, AND PREFERRED EMBODIMENTS THEREOF

The disclosures of the following patents/applications are hereby incorporated by reference as if set forth herein: U.S. Pat. No. 6,923,907 entitled “Separation Column Devices and Fabrication Methods,” and U.S. patent application Ser. No. 10/638,258 entitled “Multi-Column Separation Devices and Methods” filed Aug. 7, 2003.

### DEFINITIONS

The terms “column” or “separation column” as used herein are used interchangeably and refer to a region of a fluidic device that contains stationary phase material and is adapted to perform a chromatographic separation process.

The term “fluid phase separation process region” refers to any region adapted to perform a fluid (i.e., liquid or gas) phase chemical or biochemical analytical process such as chromatographic, electrophoretic, electrochromatographic, immunoaffinity, gel filtration, and/or density gradient separation.

The term “interpenetrably bound” as used herein refers to the condition of two adjacent polymer surfaces being bound along a substantially indistinct interface resulting from diffusion of polymer chains from each surface into the other.

The term “mass analyzer” as used herein refers to an analytical component that serves to separate ions electromagnetically based on their charge/mass ratio.

The term “microfluidic” as used herein refers to structures or devices through which one or more fluids are capable of being passed or directed and having at least one dimension less than about 500 microns.

The term “parallel” as used herein refers to the ability to concomitantly or substantially concurrently process two or more separate fluid volumes, and does not necessarily refer to a specific channel or chamber structure or layout.

The term “plurality” as used herein refers to a quantity of two or more.

The terms “transducer” as used herein refers to a component capable of detecting ions and generating a signal based on such detection.

The term “two-dimensional array” as used herein refers to a grouping of elements having at least two rows and at least two columns.

The term “vacuum enclosure” as used herein refers to an enclosure that is intended to maintain a state of sub-atmospheric internal pressure. A vacuum enclosure may include multiple internal vacuum regions.

The term “vacuum region” as used herein refers to an area that is evacuated or intended to be evacuated to a sub-atmospheric pressure. A vacuum region is contemplated to contain certain ionic species and gases.

Before the invention is described in detail, it is to be understood that this invention is not limited to the particular embodiments (e.g., devices and method steps) described and illustrated herein, since minor variations to such devices and method steps may be made within the scope of the appended claims. It is also to be understood that the terminology used herein is for purposes of describing particular embodiments, and is not intended to be limiting. Additionally, as used in the description and appended claims, the singular forms “a,” “an,” and “the” are intended to include both singular and plural referents unless the context clearly dictates otherwise.

Fluid Phase Separation Devices

As noted previously, various types of fluid phase separation devices are known, with such devices being capable of separating species in fluid samples utilizing techniques such as chromatographic, electrophoretic, electrochromatographic, immunoaffinity, gel filtration, and/or density gradient separation. Devices including multiple fluid phase separation process regions are also known. Fluid phase separation devices may include both liquid and gas phase separation devices, although liquid phase separation devices are preferred.

Various methods may be used to construct fluid phase separation devices. Simple devices may be fabricated by filling fluidic conduits such as tubes with separation media, with the separation media preferably being retained within the tube using porous screens, filters, or other conventional means.

In preferred embodiments, fluid phase separation devices are microfluidic. Conducting analyses in microfluidic scale offers numerous advantages including reduced sample and reagent usage, reduced waste generation, and improved reaction kinetics. Additionally, microfluidic devices permit a large number of separations to be conducted within a single compact device.

Traditionally, microfluidic devices have been fabricated from rigid materials such as silicon or glass substrates using surface micromachining techniques to define open channels and then affixing a cover to a channel- defining substrate to enclose the channels. There now exist a number of well-established techniques for fabricating microfluidic devices, including machining, micromachining (including, for example, photolithographic wet or dry etching), micromolding, LIGA, soft lithography, embossing, stamping, surface deposition, and/or combinations thereof to define apertures, channels or chambers in one or more surfaces of a material or that penetrate through a material. In addition to silicon and glass, microfluidic devices may now be fabricated from other materials including metals, composites, and polymers.

A preferred method for constructing microfluidic devices utilizes stencil fabrication, involving the lamination of at least three device layers including at least one stencil layer or sheet defining one or more microfluidic channels and/or other microstructures. A stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut detailed patterns through a material layer. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers mate with one or more adjacent layers (such as stencil layers or substrate layers) to form a substantially enclosed channel-containing device, typically having at least one inlet port and at least one outlet port. The resulting channel(s) typically have substantially rectangular cross-sections.

A wide variety of materials may be used to fabricate microfluidic devices with sandwiched stencil layers, including polymeric, metallic, and/or composite materials, to name a few. Various preferred embodiments utilize porous materials including filtration media. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

Device layers may be directly bonded without using adhesives to provide high bond strength (which is especially desirable for high-pressure applications) and eliminate potential compatibility problems between such adhesives and solvents and/or samples. For example, in one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure column packing methods. In another embodiment, multiple layers of 7.5-mil (188 micron) thickness “Clear Tear Seal” polypropylene (American Profol, Cedar Rapids, Iowa) including at least one stencil layer may be stacked together. Several microfluidic device assemblies may be stacked together, with a thin foil disposed between each device. The stack may then be placed between insulating platens, heated at 152° C. for about 5 hours, cooled with a forced flow of ambient air for at least about 30 minutes, heated again at 146° C. for about 15 hours, and then cooled in a manner identical to the first cooling step. During each heating step, a pressure of about 0.37 psi (2.55 kPa) is applied to the microfluidic devices. Further examples of adhesiveless methods for directly bonding layers of polyolefins including unoriented polypropylene to form stencil-based microfluidic structures are disclosed in commonly assigned U.S. Patent Application Publication No. 2003/0106799 entitled “Adhesiveless Microfluidic Device Fabrication.”

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

In addition to the use of adhesives and the adhesiveless bonding methods discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

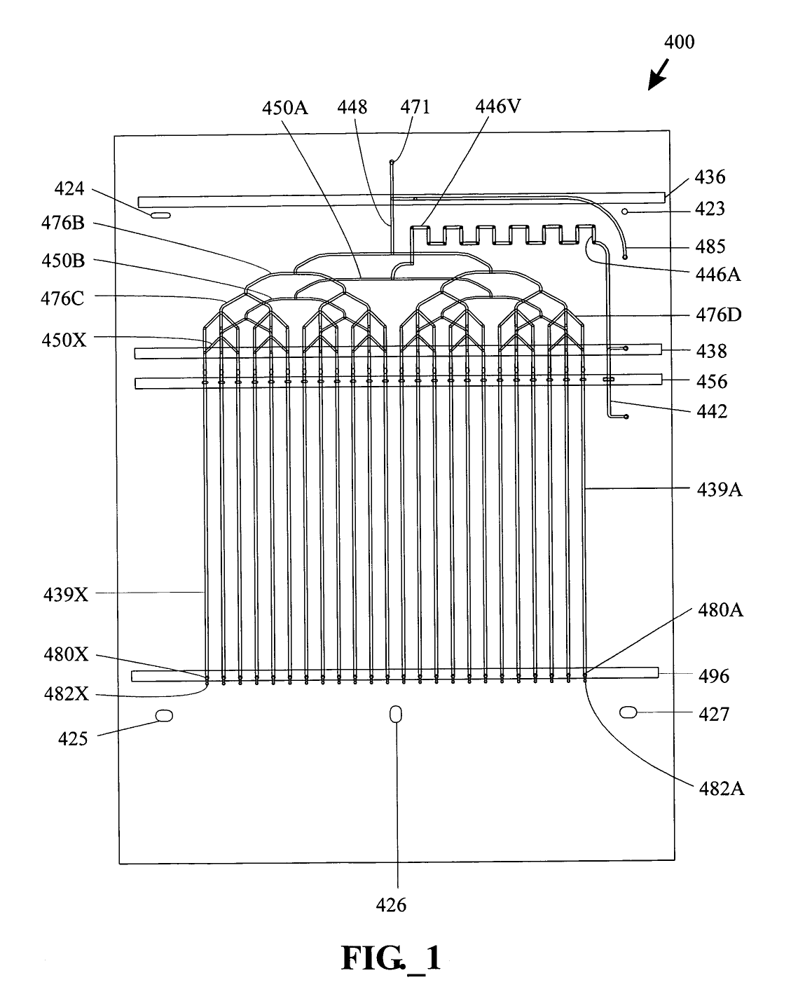

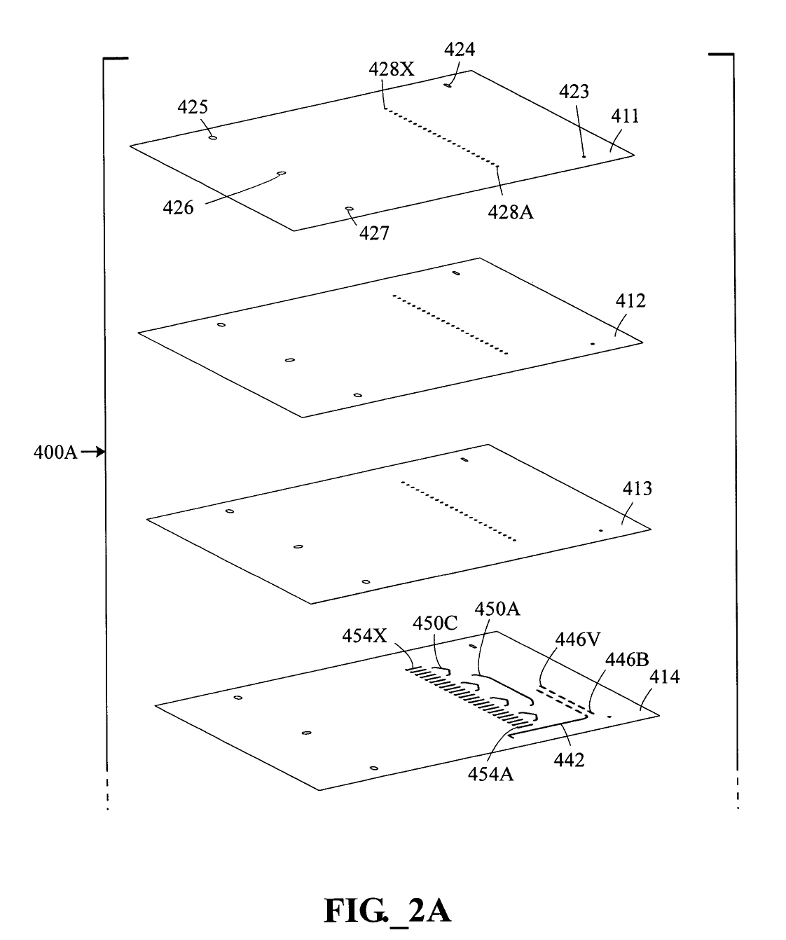

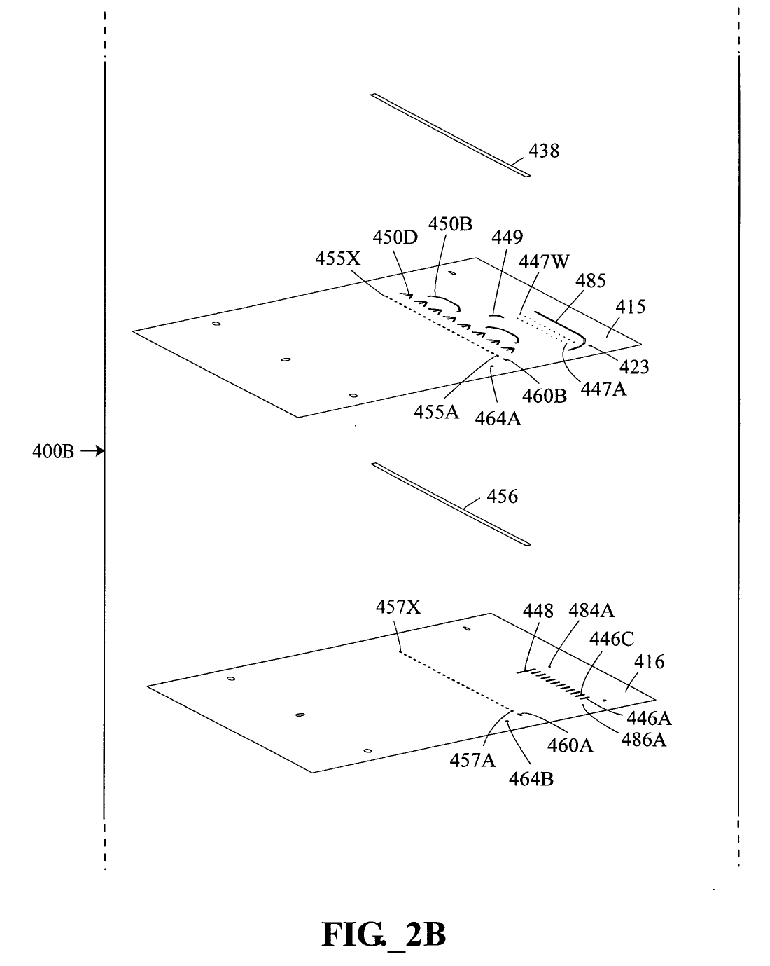

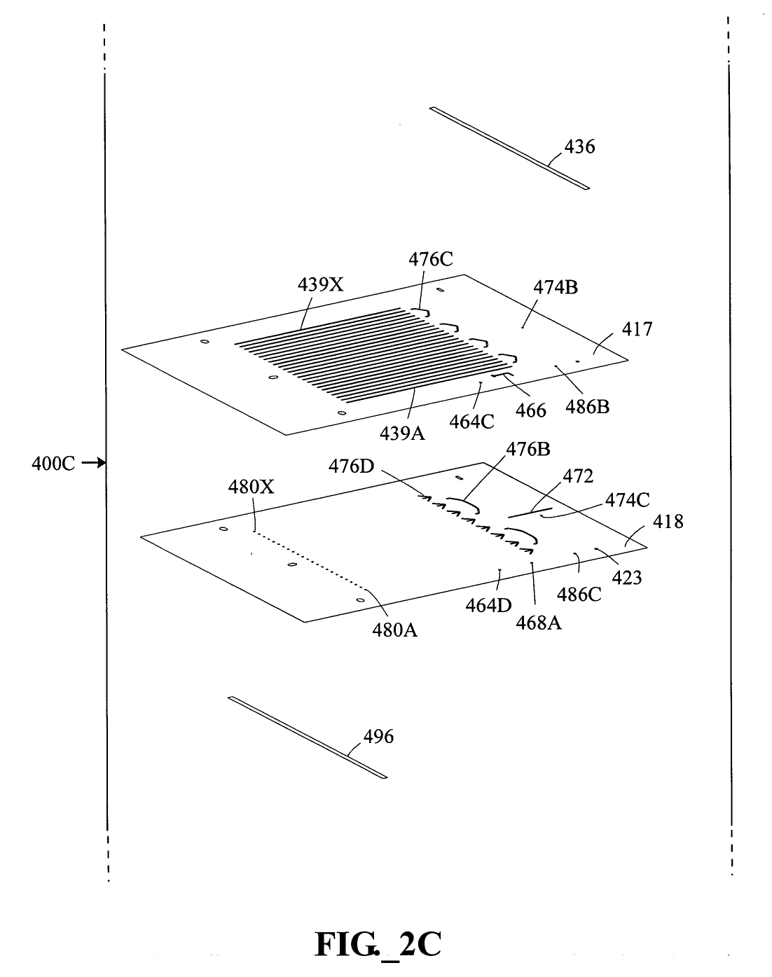

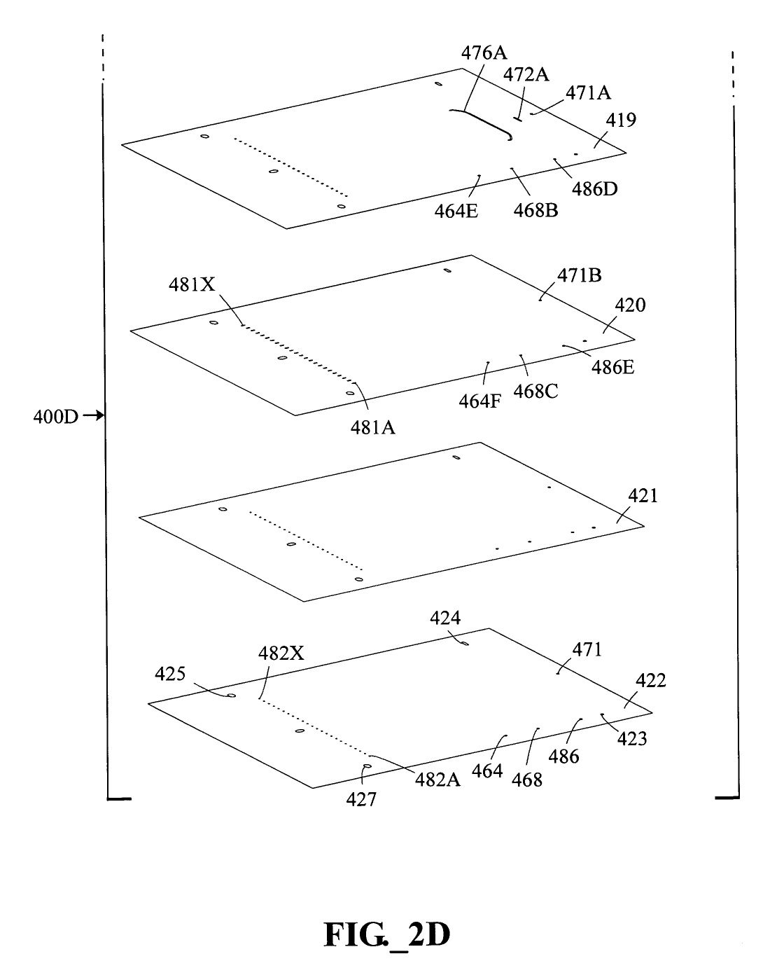

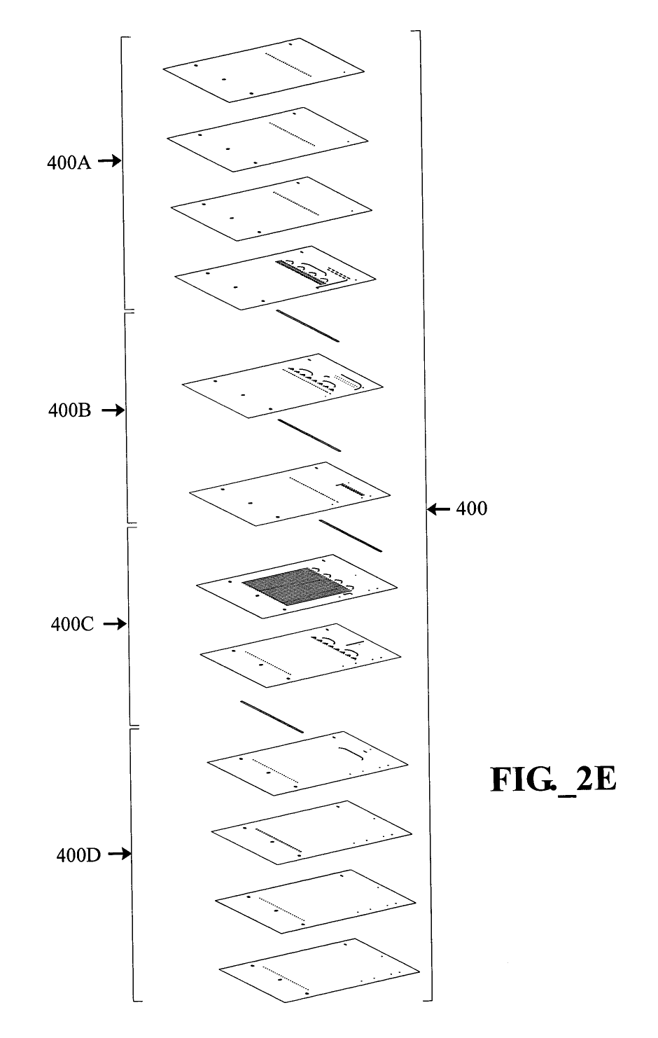

One example of a microfluidic device including multiple fluid phase analytical process regions is provided in FIGS. 1 and FIGS. 2A-2E. The device 400 includes twenty-four parallel separation channels 439A-439X containing stationary phase material for performing liquid chromatography. (Although FIG. 1 and FIGS. 2A-2E show the device 400 having twenty-four separation columns 439A-439X, it will be readily apparent to one skilled in the art that any number of columns 439A-439X may be provided. For this reason, the designation “X” is used to represent the last column 439X, with the understanding that “X” represents a variable and could represent any desired number of columns. This convention may be used elsewhere within this document.)

The device 400 is constructed with twelve device layers 411-422, including multiple stencil layers 414-420 and two outer or cover layers 411, 422. Each of the twelve device layers 411-422 defines five alignment holes 423-427, which may be used in conjunction with external pins (not shown) to aid in aligning the layers during construction or in aligning the device 400 with an external interface (not shown) during a packing process or during operation of the device 400. Press-fit interconnects may be provided with either gasketed or gasketless interfaces. Preferably, the device 400 is constructed with materials selected for their compatibility with chemicals typically utilized in performing high performance liquid chromatography, including, water, methanol, ethanol, isopropanol, acetonitrile, ethyl acetate, dimethyl sulfoxide, and mixtures thereof. Specifically, the device materials should be substantially non-absorptive of, and substantially non-degrading when placed into contact with, such chemicals. Suitable device materials include polyolefins such as polypropylene, polyethylene, and copolymers thereof, which have the further benefit of being substantially optically transmissive so as to aid in performing quality control routines (including checking for fabrication defects) and in ascertaining operational information about the device or its contents. For example, each device layer 411-422 may be fabricated from 7.5 mil (188 micron) thickness “Clear Tear Seal” polypropylene (American Profol, Cedar Rapids, Iowa).

Broadly, the device 400 includes various structures adapted to distribute particulate-based slurry material among multiple separation channels 439A-439X (to become separation columns upon addition of stationary phase material), to retain the stationary phase material within the device 400, to mix and distribute mobile phase solvents among the separation channels 439A-439X, to receive samples, to convey eluate streams from the device 400, and to convey a waste stream from the device 400.

The first through third layers 411-413 of the device 400 are identical and define multiple sample ports/vias 428A-428X that permit samples to be supplied to channels 454A-454X defined in the fourth layer 414. While three separate identical layers 411-413 are shown (to promote strength and increase the aggregate volume of the sample ports/vias 428A-428X to aid in sample loading), a single equivalent layer (not shown) having the same aggregate thickness could be substituted. The fourth through sixth layers 414-416 define a mobile phase distribution network 450 (including elements 450A-450D) adapted to split a supply of mobile phase solvent among twenty-four channel loading segments 454A-454X disposed just upstream of a like number of separation channels (columns) 439A-439X. Upstream of the mobile phase distribution network 450, the fourth through seventh layers 414-417 further define mobile phase channels 448-449 and structures for mixing mobile phase solvents, including a long mixing channel 442, wide slits 460A-460B, alternating channel segments 446A-446V (defined in the fourth and sixth layers 414-416) and vias 447A-447W (defined in the fifth layer 415).

Preferably, the separation channels 439A-439X are adapted to contain stationary phase material such as, for example, silica-based particulate material to which hydrophobic C-18 (or other carbon-based) functional groups have been added. One difficulty associated with prior microfluidic devices has been retaining small particulate matter within separation columns during operation. The present device 400 overcomes this difficulty by the inclusion of a downstream porous frit 496 and a sample loading porous frit 456. Each of the frits 456, 496 (and frits 436, 438) may be fabricated from strips of porous material, e.g., 1-mil thickness Celgard 2500 polypropylene membrane (55% porosity, 0.209×0.054 micron pore size, Celgard Inc., Charlotte, N.C.) and inserted into the appropriate regions of the stacked device layers 411-422 before the layers 411-422 are laminated together. The average pore size of the frit material should be smaller than the average size of the stationary phase particles. Preferably, an adhesiveless bonding method such as one of the methods described previously herein is used to interpenetrably bond the device layers 411-422 (and frits 436, 438, 456, 496) together. Such methods are desirably used to promote high bond strength (e.g., to withstand operation at high internal pressures of preferably at least about 100 psi (690 kPa), more preferably at least about 500 psi (3450 kPa)) and to prevent undesirable interaction between any bonding agent and solvents and/or samples to be supplied to the device 400.

A convenient method for packing stationary phase material within the separation channels 439A-439X is to provide it in the form of a slurry (i.e., particulate material mixed with a solvent such as acetonitrile). Slurry is supplied to the device 400 by way of a slurry inlet port 471 and channel structures defined in the seventh through ninth device layers 417-419. Specifically, the ninth layer 419 defines a slurry via 471A, a waste channel segment 472A, and a large forked channel 476A. The eighth device layer 418 defines two medium forked channels 476B and a slurry channel 472 in fluid communication with the large forked channel 476A defined in the ninth layer 419. The eighth layer 418 further defines eight smaller forked channels 476D each having three outlets, and twenty-four column outlet vias 480A-480X. The seventh layer 417 defines four small forked channels 476C in addition to the separation channels 439A-439X. In the aggregate, the large, medium, small, and smaller forked channels 476A-476D form a slurry distribution network that communicates slurry from a single inlet (e.g., slurry inlet port 471) to twenty-four separation channels 439A-439X (to become separation columns 439A-439X upon addition of stationary phase material). Upon addition of particulate-containing slurry to the separation channels 439A-439X, the particulate stationary phase material is retained within the separation channels by one downstream porous frit 496 and by one sample loading porous frit 456. After stationary phase material is packed into the columns 439A-439X, a sealant (preferably substantially inert such as UV-curable epoxy) may be added to the slurry inlet port 471 to prevent the columns from unpacking during operation of the device 400. The addition of sealant should be controlled to prevent blockage of the waste channel segment 472A.

As an alternative to using packed particulate material, porous monoliths may be used as the stationary phase material. Generally, porous monoliths may be fabricated by flowing a monomer solution into a channel or conduit, and then activating the monomer solution to initiate polymerization. Various formulations and various activation means may be used. The ratio of monomer to solvent in each formulation may be altered to control the degree of porosity of the resulting monolith. A photoinitiator may be added to a monomer solution to permit activation by means of a lamp or other radiation source. If a lamp or other radiation source is used as the initiator, then photomasks may be employed to localize the formation of monoliths to specific areas within a fluidic separation device, particularly if one or more regions of the device body are substantially optically transmissive. Alternatively, chemical initiation or other initiation means may be used. Numerous recipes for preparing monolithic columns suitable for performing chromatographic techniques are known in the art. In one embodiment a monolithic ion-exchange column may be fabricated with a monomer solution of about 2.5 ml of 50 millimolar neutral pH sodium phosphate, 0.18 grams of ammonium sulfate, 44 microliters of diallyl dimethlyammonium chloride, 0.26 grams of methacrylamide, and 0.35 grams of piperazine diacrylamide.

To prepare the device 400 for operation, one or more mobile phase solvents may be supplied to the device 400 through mobile phase inlet ports 464, 468 defined in the twelfth layer 422. These solvents may be optionally pre-mixed upstream of the device 400 using a conventional micromixer. Alternatively, these solvents may be conveyed through several vias (464A-464F, 468A-468C) before mixing. One solvent is provided to the end of the long mixing channel 442, while the other solvent is provided to a short mixing segment 466 that overlaps the mixing channel 442 through wide slits 460A-460B defined in the fifth and sixth layers 415, 416, respectively. One solvent is layered atop the other across the entire width of the long mixing channel 442 to promote diffusive mixing. To ensure that the solvent mixing is complete, however, the combined solvents also flow through an additional mixer composed of alternating channel segments 446A-446V and vias 447A-447W. The net effect of these alternating segments 446A-446V and vias 447A-447W is to cause the combined solvent stream to contract and expand repeatedly, augmenting mixing between the two solvents. The mixed solvents are supplied through channel segments 448, 449 to the distribution network 450 including one large forked channel 450A each having two outlets, two medium forked channels 450B each having two outlets, four small forked channels 450C each having two outlets, and eight smaller forked channels 450D each having three outlets.

Each of the eight smaller forked channels 450A-450D is in fluid communication with three of twenty-four sample loading channels 454A-454X. Additionally, each sample loading channel 454A-454X is in fluid communication with a different sample loading port 428A-428X. Two porous frits 438, 456 are disposed at either end of the sample loading channels 454A-454X. While the first frit 438 technically does not retain any packing material within the device, it may be fabricated from the same material as the second frit 456, which does retain packing material within the columns 439A-439X by way of several vias 457A-457X. To prepare the device 400 for sample loading, solvent flow is temporarily interrupted, an external interface (not shown) previously covering the sample loading ports 428A-428X is opened, and samples are supplied through the sample ports 428A-428X into the sample loading channels 454A-454X. The first and second frits 438, 456 provide a substantial fluidic impedance that prevents fluid flow through the frits 438, 456 at low pressures. This ensures that the samples remain isolated within the sample loading channels 454A-454X during the sample loading procedure. Following sample loading, the sample loading ports 428A-428X are again sealed (e.g., with an external interface) and solvent flow is re-initiated to carry the samples onto the separation columns 439A-439X defined in the seventh layer 417.

While the bulk of the sample and solvent that is supplied to each column 439A-439X travels downstream through the columns 439A-439X, a small split portion of each travels upstream through the columns in the direction of the waste port 485. The split portions of sample and solvent from each column that travel upstream are consolidated into a single waste stream that flows through the slurry distribution network 476, through a portion of the slurry channel 472, then through the short waste segment 472A, vias 474C, 474B, a frit 436, a via 484A, a waste channel 485, vias 486A-486E, and through the waste port 486 to exit the device 400. The purpose of providing both an upstream and downstream path for each sample is to prevent undesirable cross-contamination from one separation run to the next, since this arrangement prevents a portion of a sample from residing in the sample loading channel during a first run and then commingling with another sample during a subsequent run.

Either isocratic separation (in which the mobile phase composition remains constant) or, more preferably, gradient separation (in which the mobile phase composition changes with time) may be performed. If multiple separation columns are provided in a single integrated device (such as the device 400) and the makeup of the mobile phase is subject to change over time, then at a common linear distance from the mobile phase inlet it is desirable for mobile phase to have a substantially identical composition from one column to the next. This is achieved with the device 400 due to two factors: (1) volume of the path of each (split) mobile phase solvent substream is substantially the same to each column; and (2) each flow path downstream of the fluidic (mobile phase and sample) inlets is characterized by substantially the same impedance. The first factor, substantially equal substream flow paths, is promoted by design of the mobile phase distribution network 459. The second factor, substantial equality of the impedance of each column, is promoted by both design of the fluidic device 400 (including the slurry distribution network 476) and the fabrication of multiple columns 439A-439X in fluid communication (e.g., having a common outlet) using the slurry packing method disclosed herein. Where multiple columns are in fluid communication with a common outlet, slurry flow within the device is biased toward any low impedance region. The more slurry that flows to a particular region during the packing process, the more particulate is deposited to locally elevate the impedance, thus yielding a self-correcting method for producing substantially equal impedance from one column to the next.

While the embodiment illustrated in FIG. 1 and FIGS. 2A-2E represents a preferred fluidic device, one skilled in the art will recognize that devices according to a wide variety of other designs may be used, whether to perform parallel liquid chromatography or other fluid phase separation processes. For example, other functional structures, such as, but not limited to, sample preparation regions, fraction collectors, splitters, reaction chambers, catalysts, valves, mixers, and/or reservoirs may be provided to permit complex fluid handling and analytical procedures to be executed within a single device and/or system.

Mass Spectrometer Components And Systems

To overcome drawbacks associated with conventional systems including multiple fluid phase separation process regions coupled to a single MS analyzer, preferred embodiments herein utilize a mass spectrometer having multiple inlets, multiple mass analyzers, and multiple transducers/detectors to conduct parallel mass analyses of multiple samples. Preferably, the number of mass analyzers equals the number of fluid phase separation process regions to eliminate the need for periodic sampling of different sample streams into the mass spectrometer and thus eliminate the loss of data, the loss of signal clarity, and the need for fluidic switching components. Significant economies can be realized by utilizing common vacuum components and control components, thus reducing the volume and net cost per analyzer of the multi-analyzer mass spectrometer as compared to multiple single-analyzer mass spectrometers.

In one embodiment, a multi-analyzer mass spectrometer is modular, wherein the spectrometer includes a vacuum enclosure, a chassis disposed substantially within the vacuum enclosure, and multiple modules retained by the chassis, with each module including a discrete mass analyzer. Preferably, the chassis includes electrical connectors and each module is adapted to mate with a different connector such that electrical wiring within the spectrometer is greatly simplified. A preferred arrangement for the modules is in a spatially compact two-dimensional array, thus minimizing the footprint of the mass spectrometer and minimizing differences in the requisite path lengths from each fluid separation process region to each corresponding inlet of the multi-analyzer mass spectrometer.

Various multi-analyzer mass spectrometers, associated components, and related analytical systems will be discussed in more detail below.

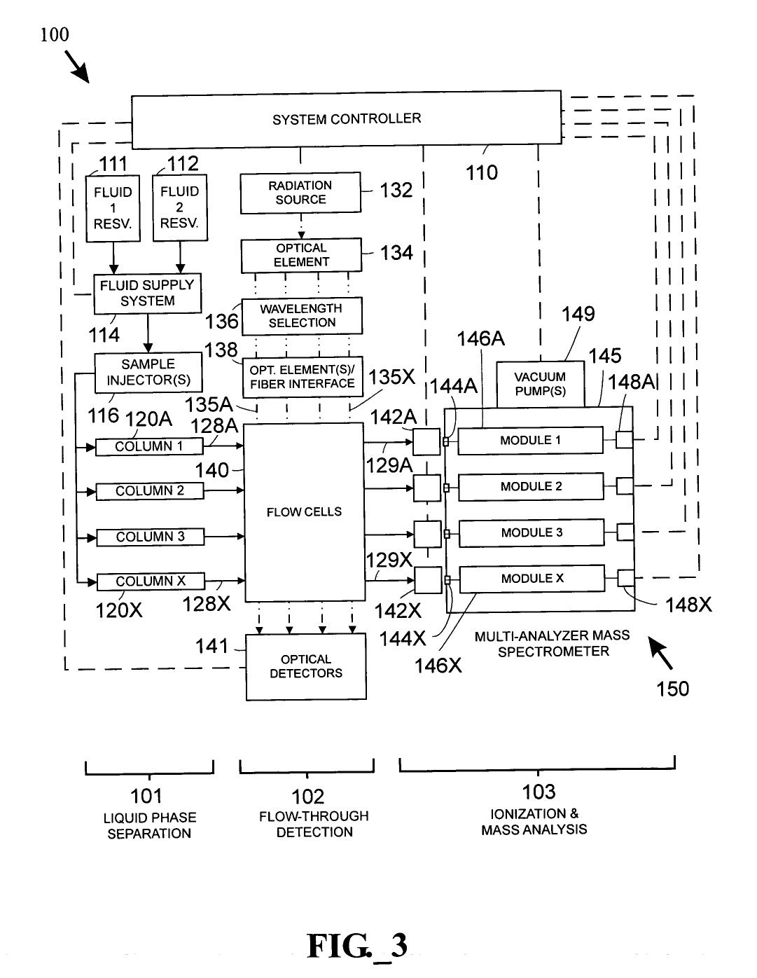

One example of a high throughput analytical system 100 is provided in FIG. 3. The system 100 includes a liquid phase separation subsystem 101, a flow-through detection subsystem 102, and an ionization and mass analysis subsystem 103. A controller 110 is preferably provided to coordinate operational control of various components of the system. The controller 110 preferably includes microprocessor-based hardware capable of executing a pre-defined or user-defined software instruction set. Data processing and display capability may also be provided by the controller 110 or a separate data processing subsystem (not shown).

The liquid phase separation subsystem 101, may be configured to permit any suitable type of liquid phase separation. In one embodiment, the liquid phase separation subsystem 101 is configured to perform parallel liquid chromatography. The subsystem 101 includes fluid reservoirs 111, 112 (e.g., containing mobile phase solvents such as water, acetonitrile, methanol, DMSO, etc.), a fluid supply system 114 (itself preferably including at least one conventional HPLC pump such as a Shimadzu LC-10AT HPLC pump (Shimadzu Scientific Instruments, Inc., Columbia, Md.) for each fluid reservoir 111, 112), sample injectors 116 such as conventional loop-type sample injection valves or a bank of dispensing needles, and multiple separation columns (or other separation process regions) 120A-120X. (While only four columns 120A-120X are illustrated, it will be readily apparent to one skilled in the art that the system 100 may be scaled to include components to perform virtually any number of simultaneous analyses.) Conventional pre-column injection may be used, or more preferably if the columns are integrated into a microfluidic device such as the device 400 described previously, then direct on-column injection may be used. Capillary conduits (e.g., capillary tubes) 128A-128X are in fluid communication with the columns 120A-120X to convey eluate streams to the flow-through detection subsystem 102. Capillary conduits 128A-128X are particularly preferred over larger-scale tubes if the separation columns 120A-120X are microfluidic to reduce band broadening of the eluate (effluent).

The flow-through detection subsystem 102 may be adapted to perform any suitable type of flow-through detection. Preferred flow-through detection methods include absorbance detection and fluorescence detection. As illustrated, the flow-through detection subsystem 102 includes a radiation source 132, optical elements 134, a wavelength selection element (or, if fluorescence detection is used, interference filter) 136, optional additional optical elements 138 (possibly including a fiber optic interface), flow cells 140, and optical detectors 141. One or more common reference signals may be provided to one or more sensors of the optical detectors 141. If absorbance (e.g., UV-Visible) detection is used, then the flow cells 140 preferably include an enhanced optical path length through the effluent streams received from the columns 120A-120X. The optical detectors 141 preferably include multiple sensors disposed in a two-dimensional array. In one example, the optical detectors 141 are embodied in a multianode photomultiplier tube having sensors disposed in an 8×8 anode array, Hamamatsu model H7546B-03 (Hamamatsu Corp., Bridgewater, N.J.). Further details regarding flow-through detection systems are provided in commonly assigned U.S. patent application Ser. No. 10/699,533 entitled “Parallel Detection Chromatography Systems,” filed Oct. 30, 2003, and commonly assigned U.S. patent application No. 60/526,916 entitled “Capillary Multi-Channel Fluorescence Detection,” filed Dec. 2, 2003, which.

Following optical detection, the sample-species-containing effluent streams are directed to the ionization and mass analysis subsystem 103, preferably by way of additional capillary conduits 129A-129X. The ionization and mass analysis subsystem 103 includes multiple ionization elements 142A-142X and a multi-analyzer mass spectrometer 150. The spectrometer 150 includes multiple inlets 144A-144X to a vacuum enclosure 145 along with multiple modules 146A-146X and detectors/transducers 148A-148X disposed within the enclosure 145. One or more common vacuum pumps 149, preferably disposed in a multi-stage arrangement, serve to evacuate the enclosure 145. Each module 146A-146X preferably includes an ion trap, at least one focusing element, and a mass analyzer. If desired, the transducers or detectors 148A-148X may be further integrated into the modules 146A-146X. Preferably, each module 146A-146X and transducer 148A-148X is in electrical communication with the controller 110 by way of a plug or other suitable electrical connector (not shown). One or more common power supplies (not shown) for use with the mass spectrometer 150 may be integrated into the system controller 110 or disposed between the controller 110 and the spectrometer 150.

In operation of the analytical system 100, samples each containing multiple species are provided to the columns 120A-120X by way of the sample injectors 116. The samples are separated into eluate (or effluent) streams each containing a series of elevated concentrations of individual species. The eluate streams are supplied to the flow cells 140 of the flow-through detection system 102 to permit suitable (e.g., optical such as absorbance and/or fluorescence) detection of the species therein. After flowing through the flow cells 140, the fluidic effluent streams are supplied to the ionization elements 142A-142X where they are ionized. While any suitable ionization technique may be used, a preferred ionization technique is electrospray ionization. The ions are supplied through the inlets 144A-144X into the mass spectrometer 150. Each ion beam is preferably supplied to a different analyzer module 146A-146X that serves to separate and sort ions based on charge to mass ratio. The ions are finally detected by the transducers 148A-148X, which supply output signals to the controller 110.

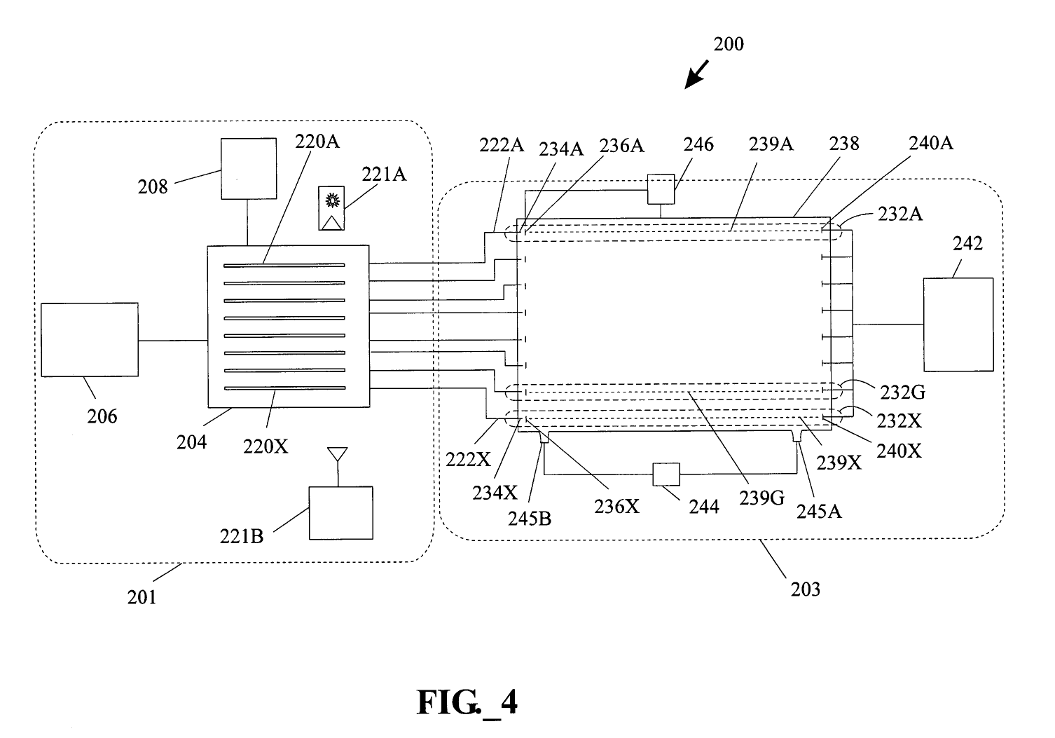

Another high throughput analytical system 200 is illustrated in FIG. 4. The system 200 includes a parallel liquid phase separation apparatus 201 and a multi-channel secondary analysis apparatus 203 preferably embodying a multi-analyzer mass spectrometer. The liquid phase separation apparatus 201 may include any suitable instrument for performing multiple parallel liquid phase separations. In one embodiment, the liquid phase separation apparatus 201 is adapted to perform parallel liquid chromatography. Multiple separation columns 220A-220X are preferably integrated into a single separation device 204. Alternatively, multiple discrete separation columns 220A-220X or other suitable liquid phase separation process regions 220A-220X may be substituted for the separation device 204.

Preferably, a common pressurization and control system 206 is used with the separation device 204. The pressurization and control system 206 may include any one or more suitable pumps or pressurization devices to distribute the mobile phase solvent to the columns 220A-220X to perform the separations. Alternatively, fluid movement may be initiated electrokinetically by the application of voltage. Samples to be analyzed are obtained from a sample source 208, which may be a conventional automated system for retrieving samples from a library, from a particular well-plate, or from any other suitable or desirable source. The sample source 208 may be automated or operated manually.

A flow-through detection apparatus 221 (encompassing elements 221A, 221B) may be included to provide a first analysis of each eluate (effluent) stream. For example, on-board optical windows (not shown) may be included in the device 204 to allow optical detection such as absorbance detection, fluorescence detection, or other desirable optical detection techniques. In a preferred embodiment, the flow-through detection apparatus 221 includes a conventional ultraviolet/visible (UV/Vis) optical detector, including a radiation source 221A and detector 221B. Alternatively, effluent from the device 204 may be routed through one or more external flow cells (such as the flow cells 140 described in connection with FIG. 3) for optical or other flow-through detection.

Multiple fluid conduits 222A-222X carry the effluent from each of the separation columns 220A-220X to the multi-channel secondary analysis apparatus 203. The conduits 222A-222X may include capillary tubing connected to the separation device 204 and/or the multi-channel secondary analysis apparatus 203 using low volume connectors, such as those described in co-pending and commonly-assigned U.S. patent application Ser. No. 10/282,392, filed Oct. 29, 2002. In one example, the conduits 222A-222X are 14.2 mils (about 360 microns) polyimide-coated fused silica tubing. The conduits may be made of any suitable material including, but not limited to, aluminum, stainless steel, glasses, polymers (such as poly[ether ether ketone] [PEEK] or polyimide), or combinations thereof.

In a preferred embodiment, the multi-channel secondary analysis apparatus 203 includes a multi-analyzer mass spectrometer 203. Alternatively, the secondary analysis apparatus 203 may include analytical components adapted to perform any other suitable type of secondary detection technique, such as but not limited to: nuclear magnetic resonance (NMR), evaporative light scattering, ion mobility spectrometry, electrochemical detection, capacitive measurement, or conductivity measurement.

The mass spectrometer 203 includes multiple parallel analysis channels 232A-232X—preferably with one channel 232A-232X being associated with each liquid phase separation process region 220A-220X. In an alternative embodiment (not shown), one mass spectrometry channel 232A-232X may be provided for some number of liquid phase separation process regions (e.g., chromatographic separation columns) 220A-220X and multiplexed. For example, one mass spectrometry channel may be provided for a set of four separation columns with a multiplexing interface. In this manner, if the liquid phase separation apparatus 291 includes twenty-four or ninety-six columns, only six or twenty-four mass spectrometry channels would be required. Of course, the limitations attendant to sampled multiplexed mass spectrometric analyses would arise. One skilled in the art may select the appropriate combination of liquid phase separation process regions, mass spectrometry channels, and interfaces therebetween to accommodate the desired and/or acceptable degree of precision and system complexity.

In a preferred embodiment, each mass spectrometry analysis channel 232A-232X includes a time-of-flight (TOF) mass analyzer. In a preferred embodiment, a single vacuum enclosure 238 surrounds all of the channels 232A-232X. A multi-stage vacuum system 244 is provided to evacuate the vacuum enclosure 238 to the desirable level of vacuum/reduced absolute pressure.

Each channel 232A-232X includes an ionization element 234A-234X, which may be disposed inside or outside the vacuum enclosure 238. In a preferred embodiment suitable for analyzing large, complex molecules, each ionization element 234A-234X preferably includes an electrospray injector. Electrospray is a “soft” ionization technique. That is, electrospray does not rely on extremely high temperatures or extremely high voltages (relative to other techniques) to accomplish ionization, which is advantageous for analyzing large, complex molecules that tend to decompose under harsh conditions. Electrospray uses the combination of an applied electric field and compressed gas to generate charged droplets of the sample solution. Applying dry gas in conjunction with a vacuum causes the sample droplets to grow increasingly smaller until desolvated, charged sample molecules are produced.

One or more voltage sources 246 provide an electric potential to focusing elements (or “ion optics”) 236A-236X to direct the ionized sample molecules along the flight path 239A-239X of each channel 232A-232X. Each focusing element 236A-236X preferably includes one or more charged plates each defining a central aperture through which ions are directed. The voltage source 246 also may provide an electric potential to the enclosure 238 to minimize, neutralize, or eliminate any undesirable electromagnetic fields within the enclosure 238. In addition, the voltage source 246 may provide the desired potential to the ionization elements 234A-234X. Alternatively, independent voltage sources (not shown) may be provided for each function.

Multiple transducers 240A-240X are provided for detecting ions, with one each transducer 240A-240X preferably corresponding to a different analysis channel 239A-239X. The transducers 240A-240X may include microchannel plates, photomultiplier tubes, channel electron multipliers, or other suitable ion detectors. The transducers 240A-240X communicate with a processor 242 that preferably processes and stores signals received from the transducers 240A-240X. In one embodiment, each transducer 240A-240X may include an individual sensor of a multi-channel detector having multiple discrete detection regions. Of course, various focusing elements, mass analyzers, and transducers are known and understood by those skilled in the art, and any combination thereof may be selected to provide the most desirable operating characteristics for the particular application.

In a preferred embodiment where the secondary analysis apparatus performs TOF mass analysis, high voltage (typically about ten to twenty kilovolts) may be applied to the focusing elements 236A-236X to accelerate and “focus” the ions so that the ions form a substantially linear beam along each flight path 239A-239X through the channels 232A-232X to the transducers 240A-240X. In an alternative embodiment utilizing quadrupole analysis (discussed below), the flight path for each ion is selectively altered to determine ion content; however, focusing may still be desirable to assure that each flight path begins at a desirable point within the apparatus 203. Once the ions have passed the focusing elements 236A-236X, the voltage of the enclosure 238 may be held at a potential that allows ions to float freely down a flight path 239A-239X with little or no electrostatic interaction with the enclosure 238, the outside environment, or ions traveling in adjacent channels 232A-232X.

Because external forces are substantially neutralized, ions travel down a flight path 239A-239X at a velocity proportional to the force applied by the focusing elements 236A-236X, and the charge and mass of the ions. Thus, smaller ions pass from the focusing elements 236A-236X to the transducers 240A-240X faster than larger ions. The charge of an ion also affects the duration of its travel from an ionization element 234A-234X to a transducer 240A-240X. A transducer 240A-240X is preferably provided for each ionization element 234A-234X and is controlled by time-resolved electronics included in the processor 242 so that each stream of ions may be analyzed separately.

Also, vacuum is preferably maintained within the enclosure 238 to prevent the ions from colliding with ambient molecules, which would distort their flight paths. Thus, the enclosure 238 is preferably capable of maintaining sufficient vacuum to prevent such undesirable interactions (typically below about 10−4 torr). In a preferred embodiment, two or more vacuum ports 245A, 245B are positioned at different points on the enclosure 238 and connected to a multi-stage vacuum pumping apparatus 244. In this manner, initial pumping can occur near the inlet portion of the enclosure 238 where new fluid is being introduced into the enclosure 238. The second (and/or third) stage pumps can be used to lower the vacuum within the enclosure 238 to a level appropriate for detection. Additional pumps (not shown) may be provided as necessary. In a preferred embodiment, the liquid phase separation apparatus 201 is microfluidic to reduce the amount of fluid to be injected into the secondary analysis apparatus 203 by a factor of ten to ten thousand as compared to conventional liquid phase separations such as liquid chromatography utilizing tubular columns, thus enabling the maintenance of vacuum conditions within the enclosure 238 without unduly large and costly vacuum pumping systems.

It is critical that the focusing elements 236A-236X, transducers 240A-240X and the enclosure 238 are positioned and controlled so that the ion beams are independent and free of electrostatic interaction. Any substantial interaction between the ion beams (electrostatic or otherwise), focusing elements 236A-236X and transducers 240A-240X may alter ion flight paths sufficiently to induce error. Additionally, if the flight paths are not carefully controlled, cross-talk between channels 232A-232X of the secondary analysis apparatus 203 may occur.

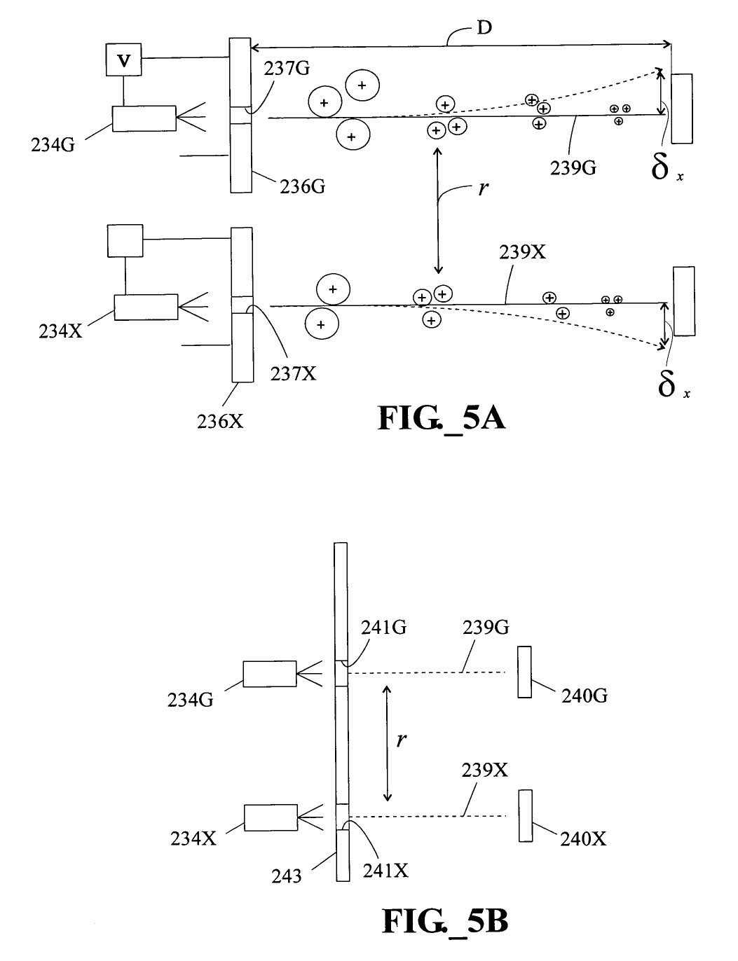

One way to provide the desired channel isolation is to provide a suitable distance between flight paths 239A-239X and sufficiently precise focusing elements 236A-236X to avoid electrostatic or physical interaction between the ion beams. Referring to FIG. 5A, the electromagnetic interaction of parallel ion beams 239G, 239X, i.e., the force F2 exerted by one beam on the other, will tend to deflect the beams some distance x. Assuming the magnetic interaction between the ion beams is negligible, the deflection of the beams x is proportional to the distance D the particles travel between the focusing elements 236G, 236X and the transducers 240G, 240X, the voltage V applied at the focusing elements 236G, 236X, the distance between the beams r, and the charge q of the ions in the beams according to the following relationship:

$${δ}_{x} = \frac{1}{16 π {ɛ}_{0}} \frac{{{D}^{}}^{2} q}{{Vr}^{2}}$$

Tables 1 and 2 below show the anticipated beam deflection of beams having charges of 500,000 electrons (e.g., 500,000 ions having a charge of one electron) and 1,000,000 electrons, respectively. The deflections are calculated for a range of travel distances and ion optic voltages.

TABLE 1

| | | | | |
|---|---|---|---|---|
| Charge (q) | 500,000e | 500,000e | 500,000e | 500,000e |
| Distance (D) | 10 cm | 20 cm | 10 cm | 20 cm |
| Ion Optics | 10 kV | 10 kV | 20 kV | 20 kV |
| Voltage (V) | | | | |

| Distance between | Deflection | Deflection | Deflection | Deflection |
|---|---|---|---|---|
| beams (r) | (δ ₓ) (cm) | (δ ₓ) (cm) | (δ ₓ) (cm) | (δ ₓ) (cm) |
| 0.01 cm | 1.798 | 7.193 | 0.899 | 3.597 |
| 0.05 cm | 0.072 | 0.29 | 0.036 | 0.14 |
| 0.1 cm | 0.018 | 0.072 | 0.009 | 0.036 |
| 0.5 cm | 0.0007 | 0.003 | 0.0004 | 0.001 |
| 1 cm | 0.0002 | 0.0007 | 0.00009 | 0.0004 |

TABLE 2

| | | | | |
|---|---|---|---|---|
| Charge (q) | 1,000,000e | 1,000,000e | 1,000,000e | 1,000,000e |
| Distance (D) | 10 cm | 20 cm | 10 cm | 20 cm |
| Ion Optics | 10 kV | 10 kV | 20 kV | 20 kV |
| Voltage (V) | | | | |

| Distance between | Deflection | Deflection | Deflection | Deflection |
|---|---|---|---|---|
| beams (r) | (δ ₓ) (cm) | (δ ₓ) (cm) | (δ ₓ) (cm) | (δ ₓ) (cm) |
| 0.01 cm | 3.597 | 14.387 | 1.798 | 7.193 |
| 0.05 cm | 0.14 | 0.57 | 0.072 | 0.287 |
| 0.1 cm | 0.036 | 0.14 | 0.018 | 0.072 |
| 0.5 cm | 0.001 | 0.006 | 0.0007 | 0.003 |
| 1 cm | 0.0004 | 0.001 | 0.0002 | 0.0007 |

Preferably, the distance δₓ is less than half the width W of the transducer 240G, 240X associated with the ion beam. In certain embodiments, the transducers 240A-240X can be miniaturized even further with the use of technologies such as micro electro mechanical systems (MEMS) where the minimization of interaction between ion beams will become even more critical.

Physical interaction (i.e., collision between ions in the ion beams due to dispersion at the ionizer) may be minimized by providing sufficiently precise focusing elements 236A-236X to focus ion beams before they have the opportunity to disperse over the distance between adjacent channels 232A-232X. The dimensions of conventional focusing elements 236A-236X are such that the distance between channels 232A-232X, which is dictated by the physical constraints of the focusing elements 236A-236X, is typically larger than the dispersal permitted by such elements 236A-236X. Of course, more advanced or miniaturized focusing elements 236A-236X may allow a higher channel density; however, the precision of the focusing elements 236A-236X may be adjusted accordingly if necessary.

Referring to Table 2, for a 0.1 cm diameter detection region, in order to keep the deflection within about one percent of the total detector area of a transducer, each detector needs to be at least about one centimeter apart. Therefore, in a preferred embodiment, each detector is at least about one centimeter apart from every other detector. In a more preferred embodiment intended to further reduce deflection, each detector is at least about two centimeters apart from every other detector.

For example, as illustrated in FIGS. 5A-5B, ionization elements 234A-234X (for clarity, only two channels, 232G and 232X are shown) are placed in proximity to the focusing elements 236A-236X. A voltage difference is applied between the ionization elements 234A-234X and focusing elements 236A-236X in order to accelerate the ions through apertures 237A-237X defined in the focusing elements 236A-236X and along the flight paths 239A-239X of the mass spectrometry channels 232A-232N. As shown in FIG. 5A, each channel 232A-232X may have a distinct set of focusing elements 236A-236X. As noted above, the distance between the flight paths 239A-239X is set so that no interaction between the ions occurs once they have entered the flight paths 239A-239X. Alternatively, as shown in FIG. 5B, the focusing elements may comprise a single conducting plate 243 having a series of apertures 241A-241X with each orifice 241A-241X serving as a focusing element to focus a different ion beam. Because the plate 243 acts to interconnect the apertures 241A-241X, a single voltage source may control all of the focusing elements 236A-236X simultaneously.

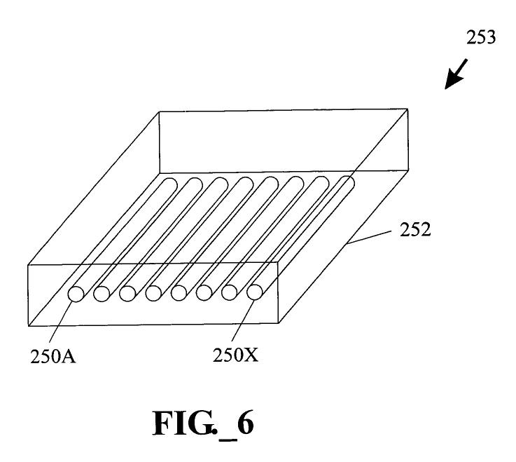

In another embodiment, such as shown in FIG. 6, a secondary analysis device 253 may include a TOF mass spectrometer having a multiple flight tubes 250A-250X with one flight tube 250A-250X for each analysis channel, wherein each tube 250A-250X acts to prevent undesirable interactions between channels. In a preferred embodiment, the flight tubes 250A-250X are cylindrical; however, other cross-sectional shapes including rectangles or squares may be used. Where discrete flight tubes 250A-250X are used, the enclosure 252 does not serve to control the flight paths of ion beams, although the enclosure 252 may be used to isolate the secondary analysis device 253 from undesirable ambient electromagnetic fields. Each flight tube 250A-250X may be independently controlled to maintain an isolated environment for each ion path. The tubes 250A-250X may be “floated” within the enclosure 252 and held in place with a non-conducting material such as (but not limited to) ceramics in order to electrically isolate each flight tube 250A-250X. When independent tubes 250A-250X are used, it may be desirable to provide a mean-free-path for molecules that allows maintenance of a desirable vacuum within each tube 250A-250X and the enclosure 252. For example, the flight tubes 250A-250X may be constructed with a material that allows the passage of gases yet maintains a sufficiently uniform electric field so as to allow the isolation of ion paths. In one embodiment, each flight tube 250A-250X is bounded by a porous metallic material such as a metal mesh to facilitate evacuation of molecules from within the enclosure 252 so as to maintain vacuum conditions therein. In another embodiment, each flight tube 250A-250X may be bounded with a solid conductive material having openings (not shown) distributed along the length of the tube 250A-250X. The openings may be sized so as to permit the electric field within the tube to remain intact while allowing the passage of molecules to be evacuated from the enclosure 252 by one or more vacuum pumps (such as embodied in the vacuum system 244 described in connection with FIG. 4).

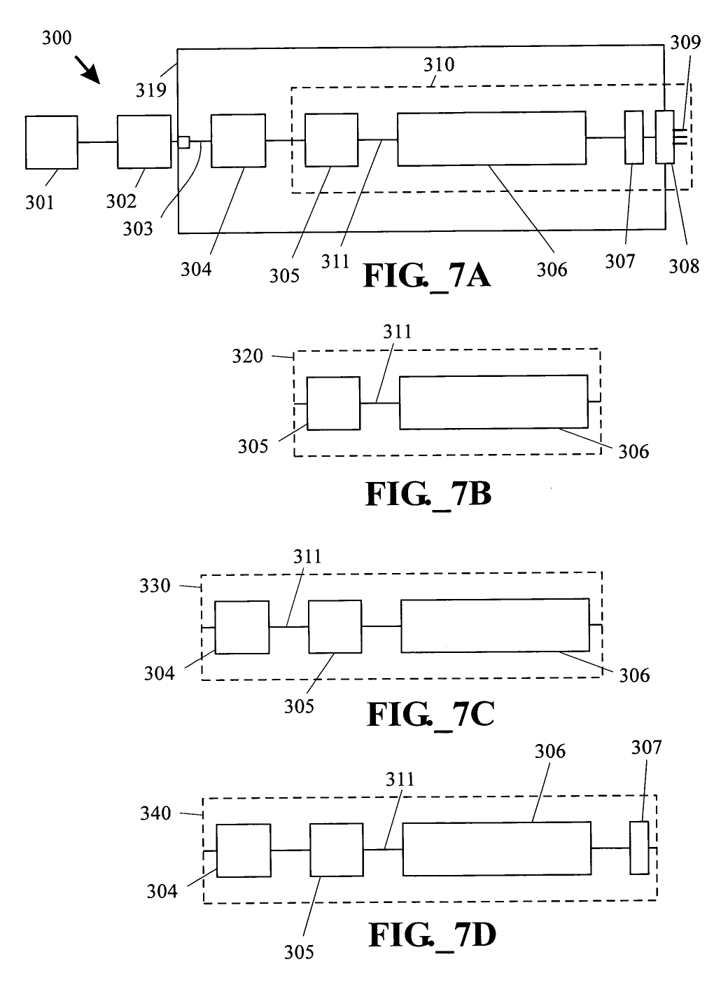

In preferred embodiments, portions of a parallel analysis apparatus such as multi-analyzer mass spectrometer can be modularized to simplify manufacturing and facilitate scalability. FIG. 7A illustrates an analytical system 300 providing mass analysis utility. The system 300 includes a liquid phase process region 301 in fluid communication with an ionization element 302. A vacuum enclosure 319 defines a sample inlet 303 adjacent to the ionization element 302. An ion trap 304 is preferably provided to trap and selectively discharge ions. Depending on the particular mass analysis technology used to separate ions within the analyzer 306, it may be useful to supply ions to the analyzer 306 in short “bursts” rather than a continuous stream, thus analysis of a first group of ions while a second group is stored in the trap 304 without being discarded. One or more focusing elements 305 are preferably disposed between the ion trap 304 and the analyzer 306. Various types of analyzers 306 may be used to separate and sort ions based on charge-to-mass ratio. A transducer 307 is disposed downstream of the analyzer 306 to detect ions and provide electrical output signals. Sample molecules travel through the system 300 along a central flow path 311. An interface plug 308 having multiple conductors 309 may be provided to connect with external components such as a power supply and/or processor (not shown), with further electrical conductors (not shown) preferably provided along the inner periphery of the enclosure 319, more preferably within each module, to permit communication with various system components. Alternatively or additionally, one or more interface plugs 308 may be disposed within the vacuum enclosure 319 where convenient or necessary.

As shown by the dashed lines in FIGS. 7A-7D, an analyzer 306 may be grouped with one or more other components to form a module 310, 320, 330, 340. Assembling adjacent components into modules helps ensure that physical alignment between critical components is maintained upon assembly of the entire device 300. Alignment is often especially critical between focusing elements 305 and the analyzer 306. Various combinations of components to form modules are shown in FIGS. 7A-7D. In FIG. 7A, the module 310 includes focusing elements 305, analyzer 306, and transducer 307 along with an interface plug 308. In FIG. 7B, the module 320 includes focusing elements 305 and an analyzer 306. In FIG. 7C, the module 330 includes an ion trap 304, focusing elements 305, and an analyzer 306. In FIG. 7D, the module 340 includes an ion trap 304, focusing elements 305, analyzer 306, and a transducer 307.

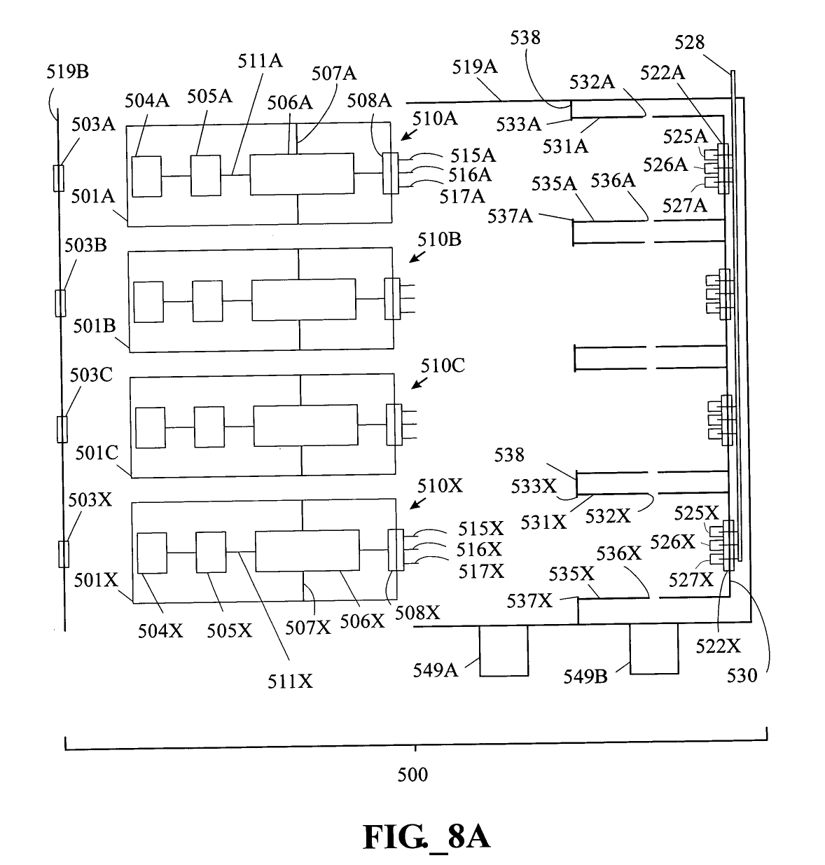

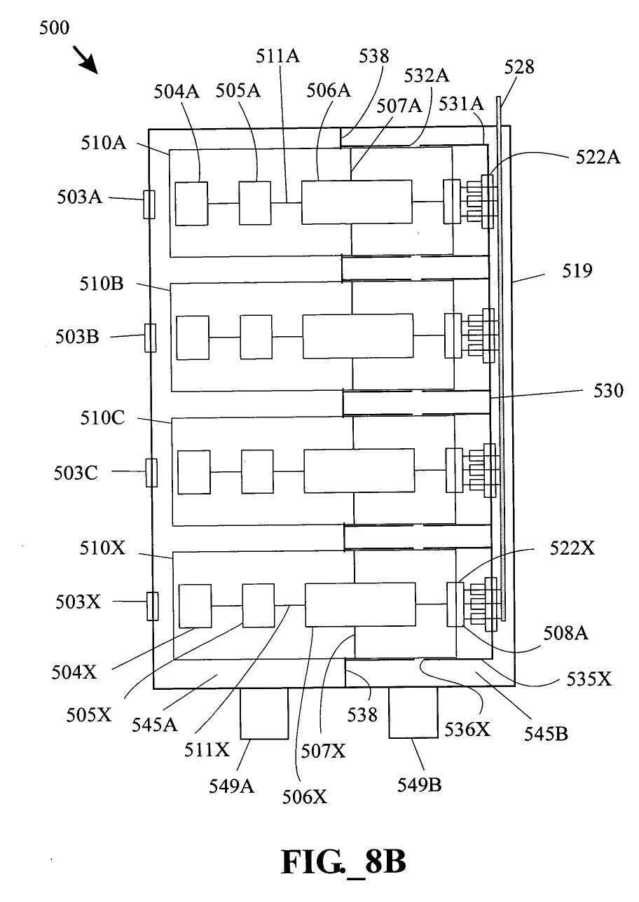

In preferred embodiments, a spectrometer includes multiple modules arranged to permit parallel analysis of multiple samples. One example of a multi-analyzer spectrometer 500 constructed with multiple modules 510A-510X is illustrated in FIGS. 8A-8B. The spectrometer 500 includes a vacuum enclosure 519 constructed in multiple portions 519A, 519B. Preferably, gasketed or equivalent seals (not shown) between the enclosure portions 519A, 519B are provided to prevent leakage of ambient air into the enclosure 519. One enclosure portion 519B defines multiple sample inlets 503A-503X, with one inlet 503A-503X being provided for each module 510A-510X. The other enclosure portion 519A supports an internal chassis 530 adapted to retain multiple modules 510A-510X. Preferably, each module 510A-510X is removably affixed to the chassis 530 to facilitate efficient fabrication of the spectrometer 500 as well as promote easy maintenance and serviceability. For each module 510A-510X, the chassis 530 preferably includes guide members 531A-531X, 535A-535X, seals 533A-533X, 537A-537X, and an interface plug 522A-522X providing connections to multiple conductors 525A-525X, 526A-526X, 527A-527X.

The spectrometer 500 preferably includes multiple vacuum pump stages 549A-549B. While only two vacuum pump stages 549A, 549B are illustrated, more vacuum stages may be provided. Preferably, differential levels of vacuum are maintained within the spectrometer 500, with progressively higher levels of vacuum (i.e., lower absolute pressures) being maintained along the direction of each ion path 511A-511X. In other words, a lower level of vacuum (or higher absolute pressure) may be maintained within the enclosure 519 adjacent to the sample inlets 503A-503X than adjacent to the detectors/transducers 508A-508X. To facilitate the maintenance of different vacuum states, the enclosure 519 is preferably partitioned into multiple subchambers using internal partitions or baffles 538 disposed substantially perpendicular to the ion paths 511A-511X. As illustrated, partition elements 538 may be disposed between various guide members 531A-531X, 535A-535X. The guide members 531A-531X, 535A-535X preferably define passages 532A-532X, 536A-536X to permit fluid (vacuum) communication with a common vacuum stage 549. Each module 510A-510X preferably includes partitions or baffles 507X-507X corresponding to the partition elements 538, and includes passages or other openings (as described previously) also in communication with the vacuum stage 549. Thus, both the enclosure 519 and modules 510A-510X include appropriate physical baffles or partitions 538, 507A-507X for maintaining different vacuum regions 545A, 545B having different absolute pressures within the spectrometer 500 using a minimum number of (e.g., common) vacuum pump stages 549A, 549B. Seals 533A-533X, 537A-537X within the enclosure 519 between the partitions 538 and the modules 510A-510X prevent vacuum leaks and facilitate maintenance of differential vacuum conditions.

The chassis 530, including the guide members 531A-531X, is preferably fabricated with suitably rigid materials to support the modules 510A-510X. In one embodiment, the chassis 530 or at least a portion thereof is fabricated with one or more electrically insulating materials such as non-conductive polymers, ceramics, or composites to promote electrical isolation of the chassis 530 from the modules 510A-510X. Alternatively, if the chassis 530 or at least a portion thereof is constructed with conductive materials, then electrically insulating spacers or standoffs (not shown) may be disposed between the chassis 530 and the modules 510A-510X.

Multiple conductors 525A-525X, 526A-526X, 527A-527X may be grouped into a bundle or electrical bus 528 to minimize the number of physical penetrations through the enclosure 519. In one embodiment, the bus 528 comprises an etched circuit board. Additionally, one or more conductors 525A-525X, 526A-526X, 527A-527X may be common to multiple modules 510A-510X (e.g., ground conductors and/or other conductors if multiple modules 510A-510X are subject to coordinated control through common control inputs) to permit such common conductors to be electrically disposed in series (e.g., “daisy-chained”) rather than requiring unnecessarily long parallel conductors for each module 510A-510X.

Each module 510A-510X includes a housing 501A-501X, an ion transfer optic element (such as a multi-pole ion trap) 504A-504X, one or more focusing elements 505A-505X, an analyzer 506A-506X, and a detector/transducer 508A-508X. Each analyzer 506A-506X may include a flight tube. Each transducer 508A-508X may include an integrally formed plug with multiple conductors 515A-515X, 516A-516X, 517A-517X for mating with corresponding conductors 525A-525X, 526A-526X, 527A-527X in the chassis plugs 522A-522X. Although only three conductors 515A-515X, 516A-516X, 517A-517X are illustrated for each module 510A-510X, it is to be appreciated that additional conductors may be provided. Additionally, each plug may be distinct from its associated transducer 508A-508X, and each module 510A-510X may include multiple plugs (not shown). Any of the various module components 504A-504X, 505A-505X, 506A-506X, 508A-508X may be aligned with one another within and mounted to their corresponding module housing 501A-501X. Partitions or baffles 507A-507X may be provided within each module 510A-510X, with each module 510A-510X preferably having multiple partitions or baffles disposed along the direction of ion travel 511A-511X through the modules 510A-510X. Each module housing 501A-501X preferably also defines multiple peripheral vacuum openings or passages (not shown) to permit fluid (vacuum) communication between interior portions of the modules 510A-510X and the vacuum pump stages 549A, 549B.

In operation, samples are supplied from external ionization elements (not shown) to the inlets 503A-503X of the spectrometer. Each (sample) ion beam is analyzed in parallel by a different module 510A-510X. Communication between the spectrometer 500 and external control components (not shown) is provided by way of the conductor bundle or bus 528.

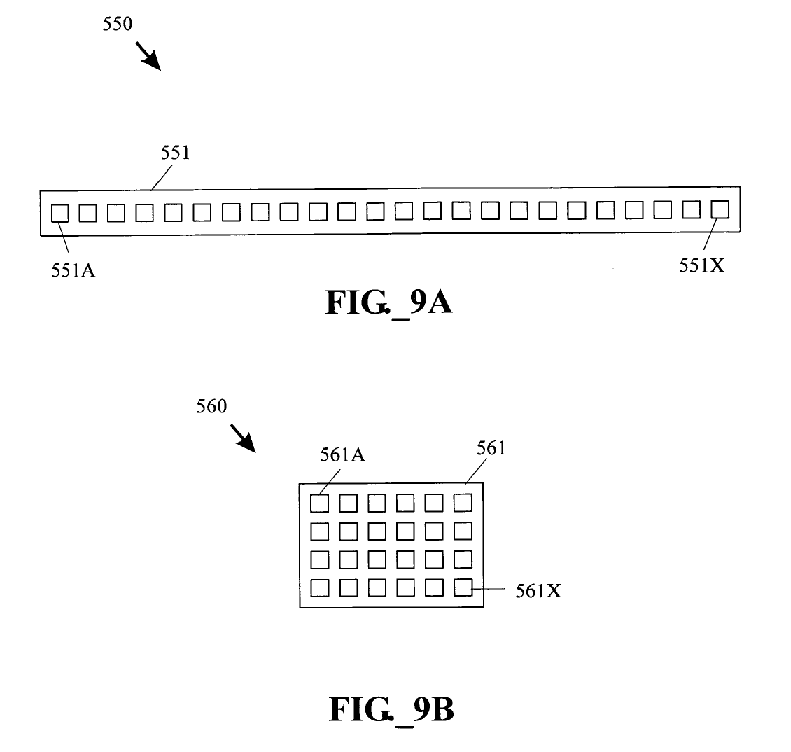

In one embodiment, fluid connections between multiple fluid phase separation process regions and a modular multi-analyzer spectrometer are provided with minimal and substantially equal path lengths. To facilitate minimal and substantially equal path lengths, a preferred arrangement for the analyzer modules is in a spatially compact two-dimensional array. Multi-analyzer spectrometers 550, 560 having large numbers of modules disposed in one-dimensional and two-dimensional arrays, respectively, are illustrated in FIGS. 9A-9B. In FIG. 9A, a spectrometer 550 includes twenty-four modules 551A-551X disposed in a single row. Particularly if the spectrometer 550 is interfaced with an external microfluidic fluid phase separation device (such as the device 400 described previously in connection with FIG. 1 and FIGS. 2A-2E) substantially smaller than the spectrometer 550, then to provide equal length fluidic interfaces for each process region and corresponding module 551A-551X many interfaces would be needlessly long. A preferred spectrometer with a more efficient module layout is provided in FIG. 9B. With the modules 561A-561X disposed in a two-dimensional array (e.g., six rows of four columns, although any number of alternative row and column arrangements may be provided) having multiple rows and multiple columns, much shorter equal-length interfaces can be provided between the spectrometer 560 and an upstream fluid phase separation device 400.

As noted previously, components facilitating analysis of different ion beams may be subject to common control. In one embodiment, components used with different spectrometer channels may be integrated. For example, FIG. 10 illustrates a multi-channel focuser 600 having multiple focusing elements 602A-602X integrated on a common support 601. Each focusing element 602A-602X includes a conductive annulus 602A-602X defining a central aperture 604A-604X permitting the passage of ions. A different ion beam may be directed through each different focusing element 602A-602X. Each focusing element 602A-602X may be controlled via one or more common conduits 605. In one embodiment, the conduits 605 terminate at an edge connector 607 having one or more contacts 608. The edge connector 607 may be inserted into an appropriate mating slot connector (not shown) such as may be provided within a surrounding enclosure or chassis. In one embodiment, the support 601 comprises a circuit board, with the conductive annuluses 602A-602X, conduits 605 and contacts 608 being fabricated according to established circuit board fabrication methods.

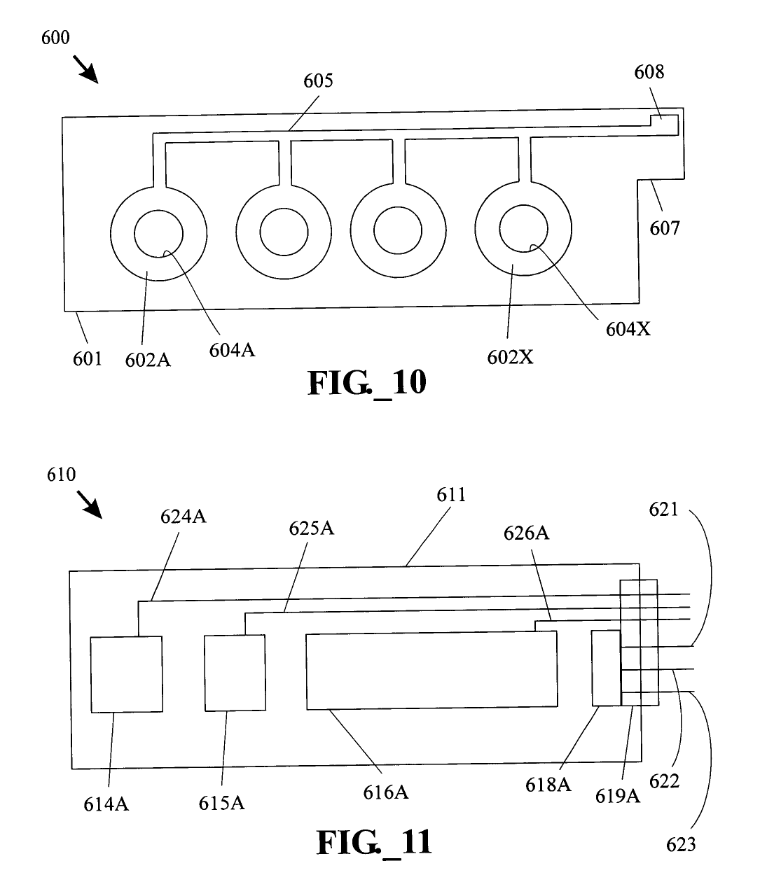

In certain embodiments, a mass analyzer module includes internal conductors leading to a common connector plug. An example of such a module 610 is provided in FIG. 11. A housing 611 provides structural support for an ion trap 614A, one or more focusing elements 615A, a mass analyzer 616A, and a transducer 618A. A connector plug 619A permits external access to several conductors 621-623, 624A-626A. Certain conductors 624A-626A may be routed substantially within or along housing 611 to transmit signals to or from internal components 614A, 615A, 616A. Routing conductors 624A-626A substantially within or along the housing 611 simplifies the packaging of multiple modules 610 into a large vacuum enclosure (not shown).

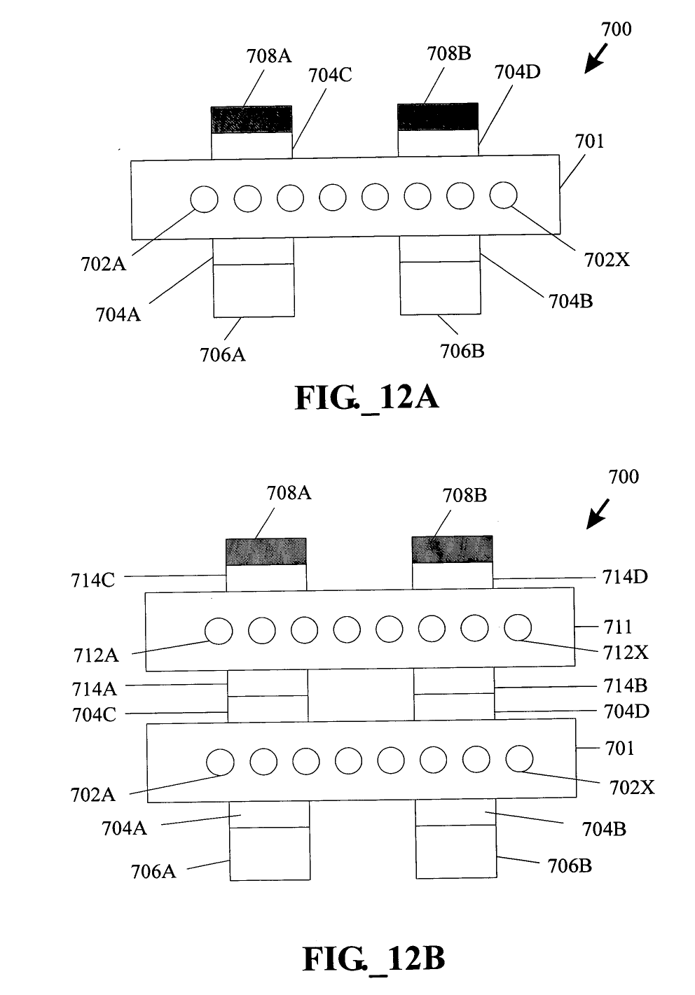

In still other embodiments, mass spectrometers may be fabricated with modular sub-assemblies each containing components for multiple analyzer channels such as illustrated in FIGS. 12A-12B. A mass spectrometer 700 includes a first subassembly 701 having multiple analysis channels 702A-702X and vacuum ports 704A-704D. Each channel 702A-702X includes a mass analyzer of any suitable type and desirable related components. A multistage vacuum system 706 including pumps 706A, 706B may be provided in fluid (vacuum) communication with one set of vacuum ports 704A, 704B while another set of vacuum ports 704C, 704D may be sealed with caps 708A, 708B. In the event that it is desired to add additional analysis channels to provide higher throughput, an additional subassembly 711 may be provided, such as illustrated in FIG. 12B. The additional subassembly 711 includes multiple analysis channels 712A-712X and vacuum ports 714A-714D. The two subassemblies 701, 711 are oriented such that vacuum ports 714A, 704B disposed along the bottom of the second subassembly 711 mate with corresponding vacuum ports 704C, 704D disposed along the top of the first subassembly 701 (following removal of the caps 706A, 706B). The caps 706A, 706B are then relocated and positioned to seal the vacuum ports 714C, 714D disposed on top of the second subassembly 711. In this manner, the multi-stage vacuum pumps 706A, 706B may be used to evacuate both the first and second subassemblies 701, 711. Any desirable number of subassemblies 701, 711 may be stacked to provide the desired number of analysis channels. The vacuum system 706 may also be augmented as necessary to maintain desired levels of vacuum within the system 700.

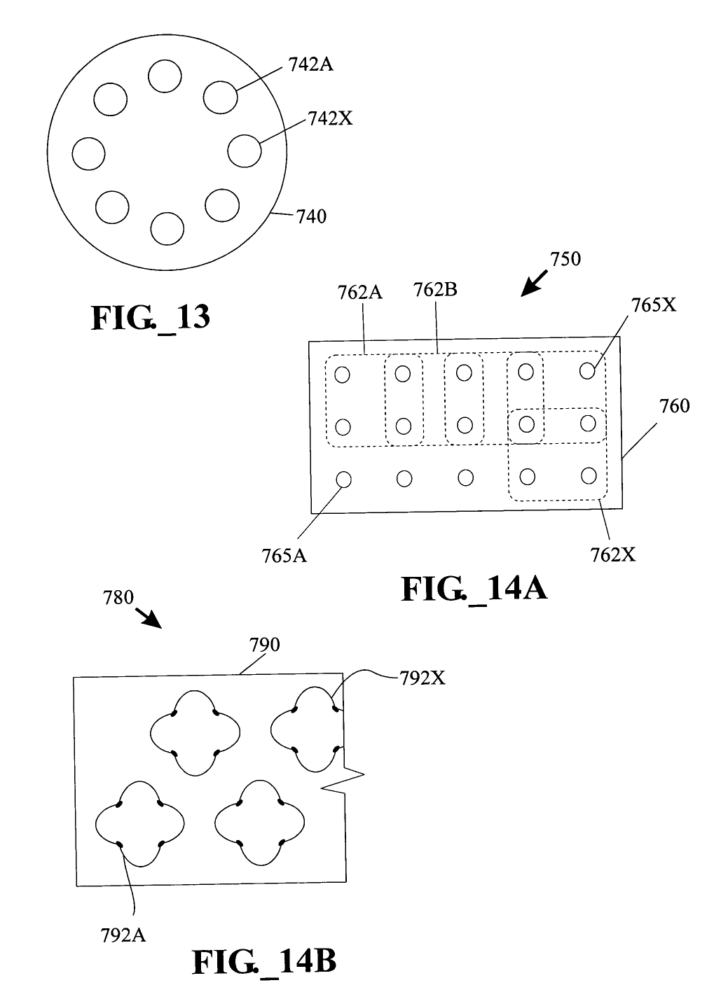

The channels of a particular mass spectrometer may be arranged within a vacuum enclosure or regions thereof in any desirable pattern. For instance, as shown in FIG. 6 and FIGS. 12A-12B, channels may be substantially co-planar. As shown in FIG. 13, mass analysis channels 742A-742X may be arranged in a circular or other pattern within a vacuum enclosure 740. It will be readily apparent to one skilled in the art that any desirable configuration may be provided so long as sufficient inter-channel spacing (and/or shielding) is provided to prevent undesirable interactions between adjacent channels 742A-742X.

In another embodiment illustrated in FIG. 14A, a mass spectrometer 750 includes a vacuum enclosure 760 containing multiple quadrupole mass analyzers 762A-762X, with adjacent analyzers 762A-762X sharing common poles 765A-765X disposed in a matrix. In still another embodiment, shown in FIG. 14B, a mass spectrometer 780 includes multiple glass flight tubes 792A-792X disposed within a vacuum enclosure 790.

In a particularly preferred embodiment, a multi-channel mass spectrometer includes at least one ionization source (more preferably, multiple ionization sources with one ionization source associated with each module), a vacuum enclosure, and multiple modules disposed substantially within the enclosure, with each module mating with the vacuum enclosure along multiple mating surfaces to define multiple sequential vacuum regions. To promote economy, each sequential vacuum region has at least one (but more preferably one) common vacuum pumping element. Preferably, at least three vacuum regions are provided; more preferably, four vacuum regions are provided. Each module includes a mass analyzer and at least one ion transfer optic element that receives ions from an ionization source and guides such ions to the mass analyzer.

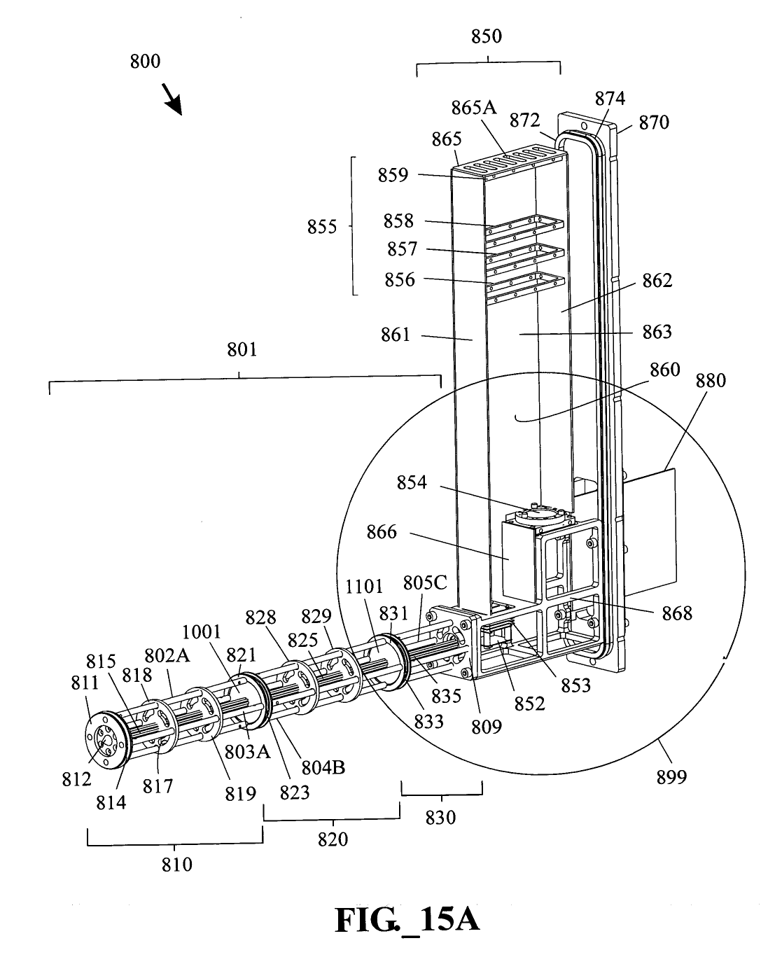

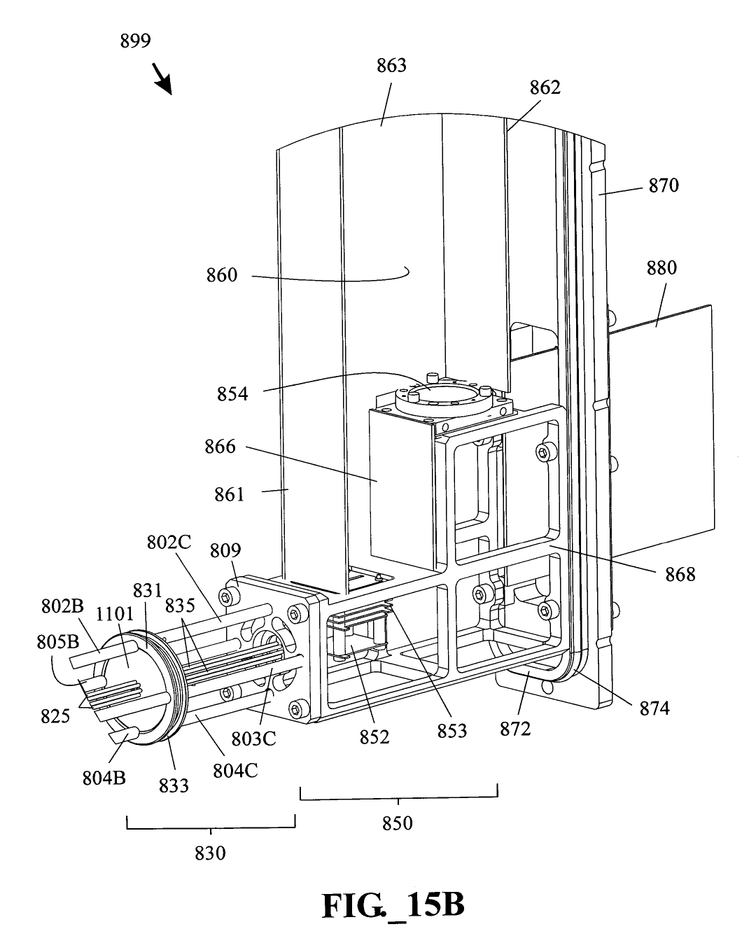

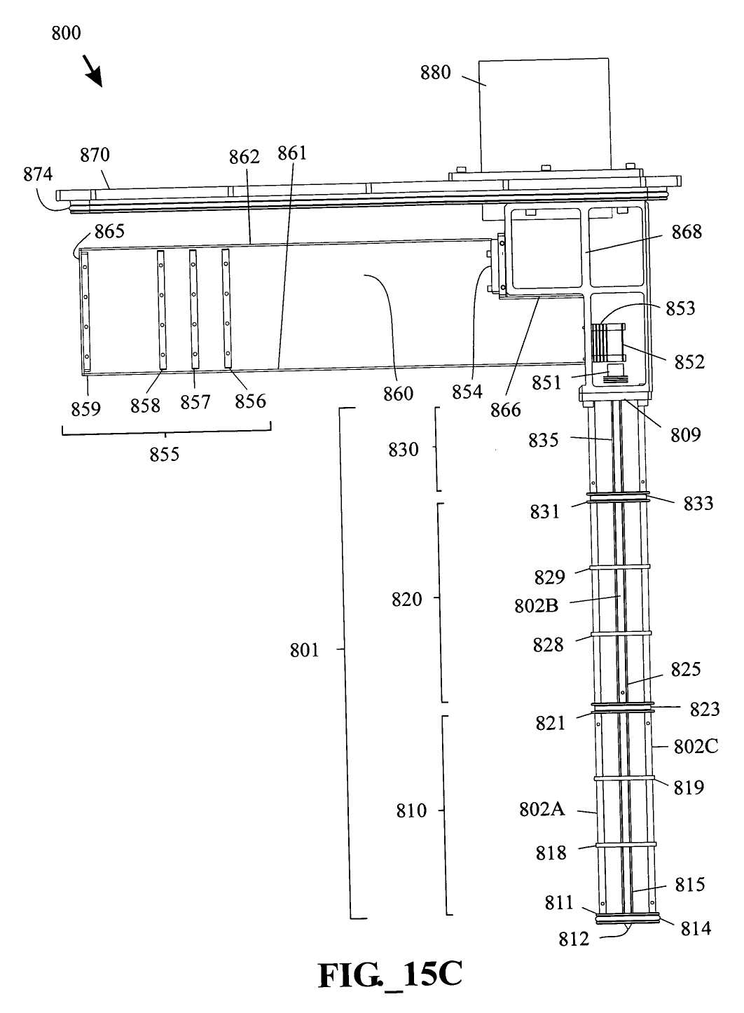

One example of a mass spectrometer module 800 is illustrated in FIGS. 15A-15C. The module 800 includes an ion transfer optic assembly 801 and a mass analyzer 850, and further includes a back plate 870 and a protruding feed through electrical interface 880 permitting electrical access to the module 800 external to an enclosure 900. A magnified view of a portion of the module 899 is provided in FIG. 15B.

The ion transfer optic assembly 801 includes three ion transfer optic elements 810, 820, 830 each intended to be independently controlled and subjected to different absolute pressure conditions, preferably by differential pumping. The first ion transfer optic element 810 is bounded longitudinally by a skimmer support 811 and a first rim member 821, the second ion transfer optic element 820 is bounded longitudinally by the first rim member 821 and a second rim member 831, and the third ion transfer optic element 830 is bounded longitudinally by the second rim member 831 and a mating flange 809 disposed along the mass analyzer section 850.

Each ion transfer optic element 810, 820, 830 includes multiple poles 815, 825, 835. Preferably, each ion transfer optic element 810, 820, 830 includes four, six, or eight poles 815, 825, 835, with an especially preferred embodiment including eight poles 815, 825, 835. During operation of the module 800, alternating current is supplied to the poles 815, 825, 835, with each pole 815, 825, 835 being maintained at opposite polarity (i.e., 180 degrees out of phase) relative to its immediately adjacent poles 815, 825, 835 to confine the ions to a beam along the central longitudinal axis of the ion transfer optic element 810, 820, 830. The frequency of the alternating current may be varied. The ions are preferably also subjected to a DC axial field gradient (which may also be varied) to accelerate the ions axially through the ion transfer optic assembly 801 or assist with mass filtering. Within each group of poles 815, 825, 835, each pole should be physically separated from its adjacent poles to permit neutral (uncharged) species to migrate (e.g., through diffusion) between the poles and away from the ion beam.

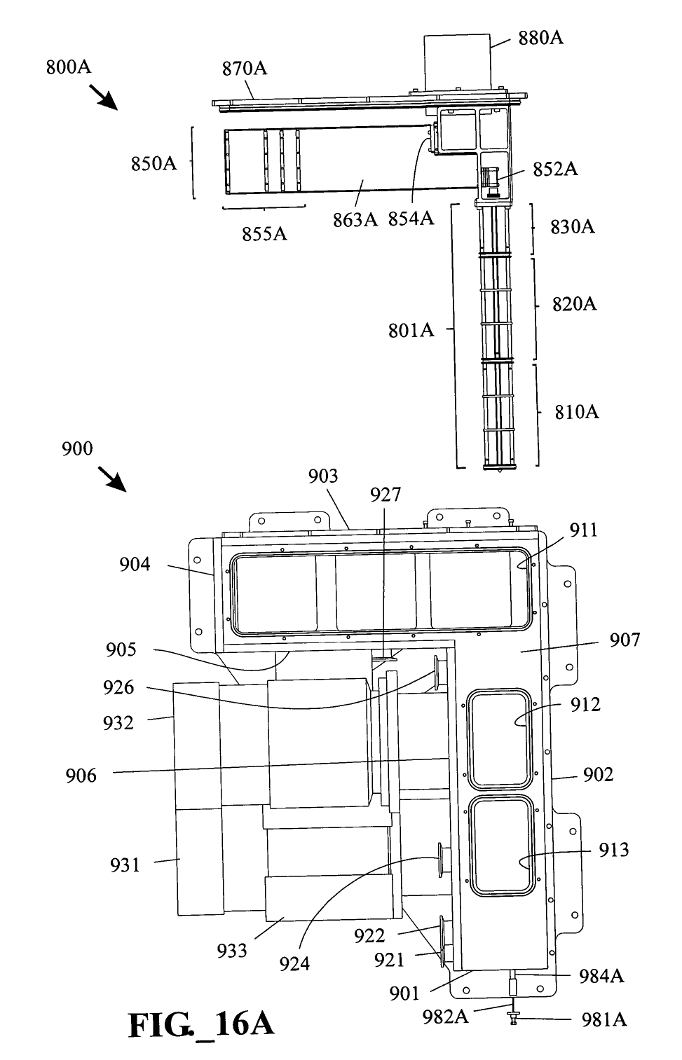

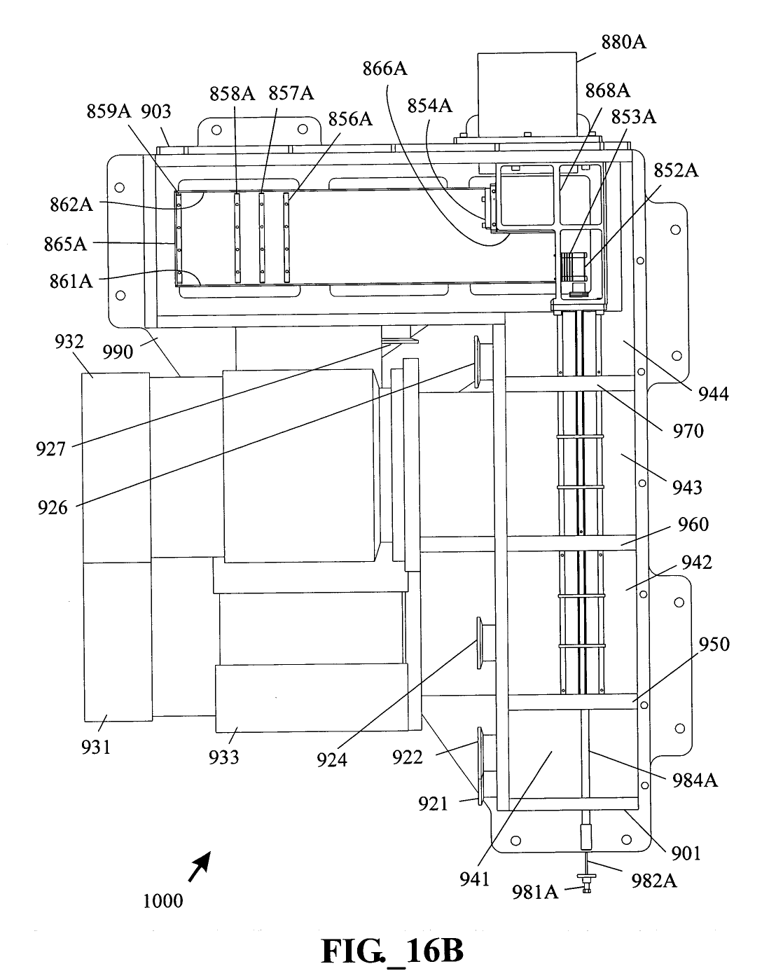

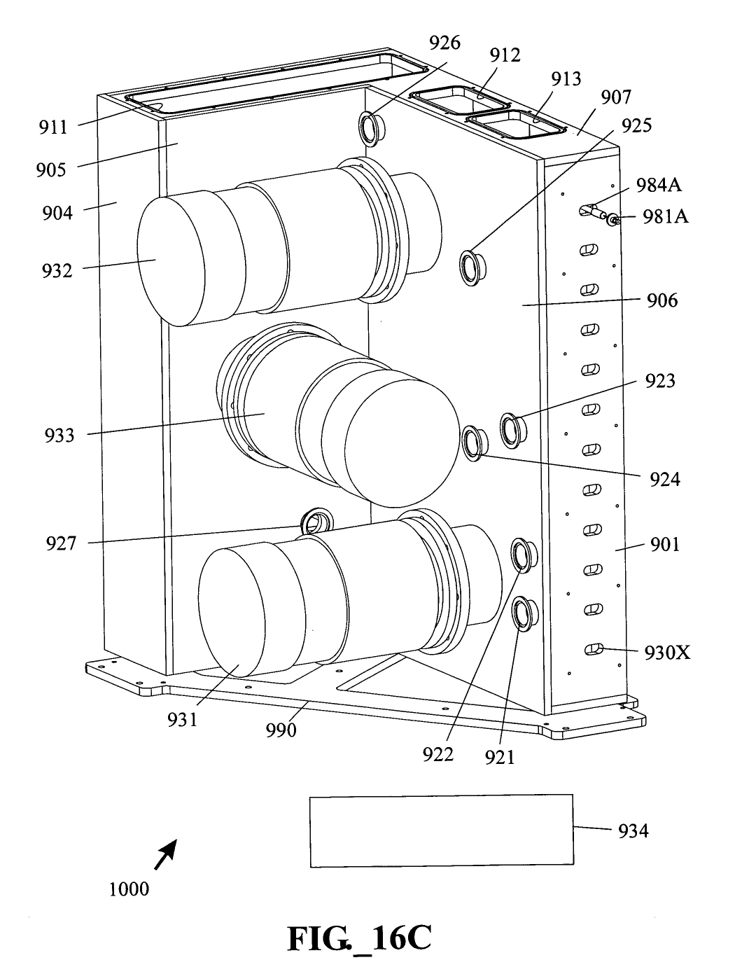

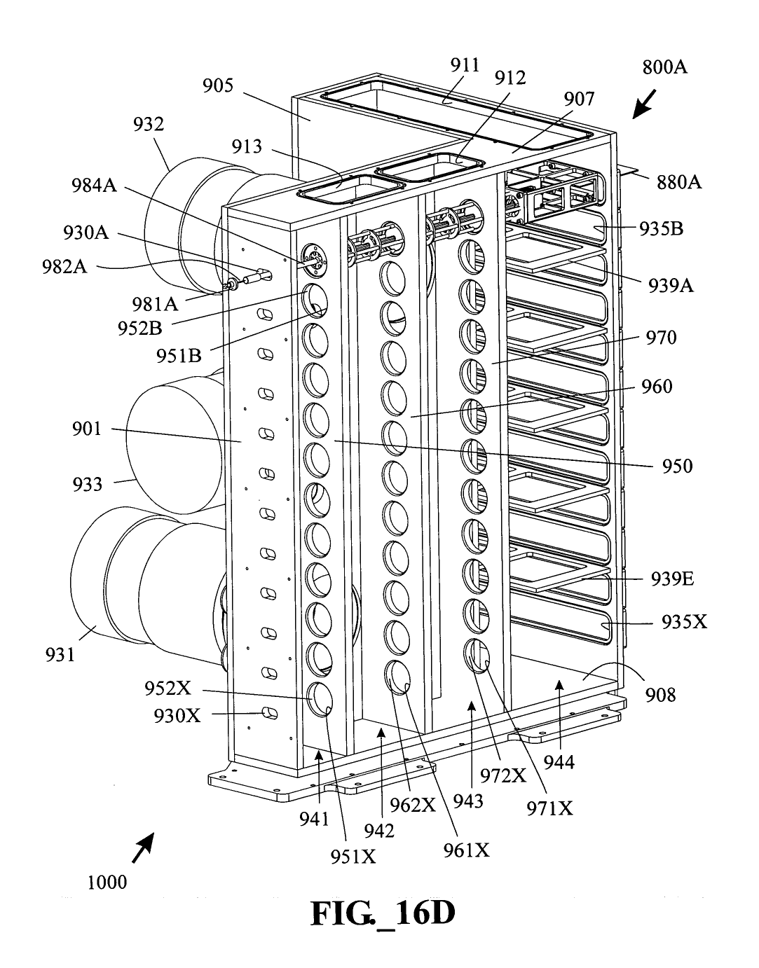

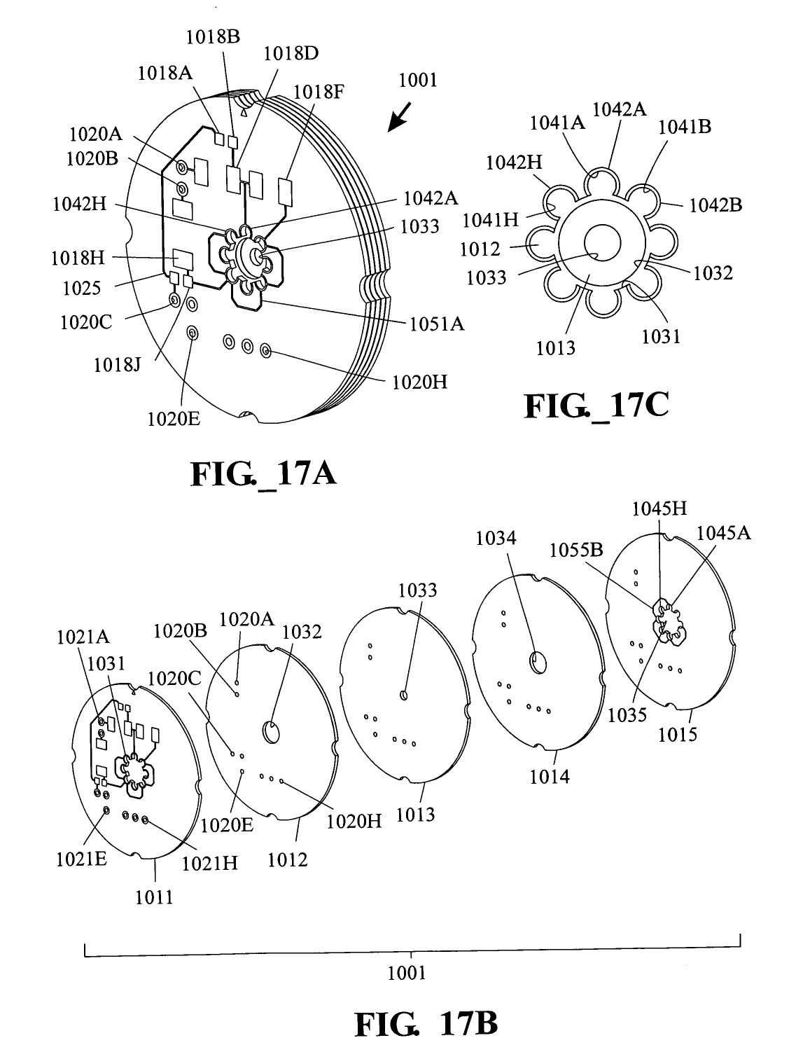

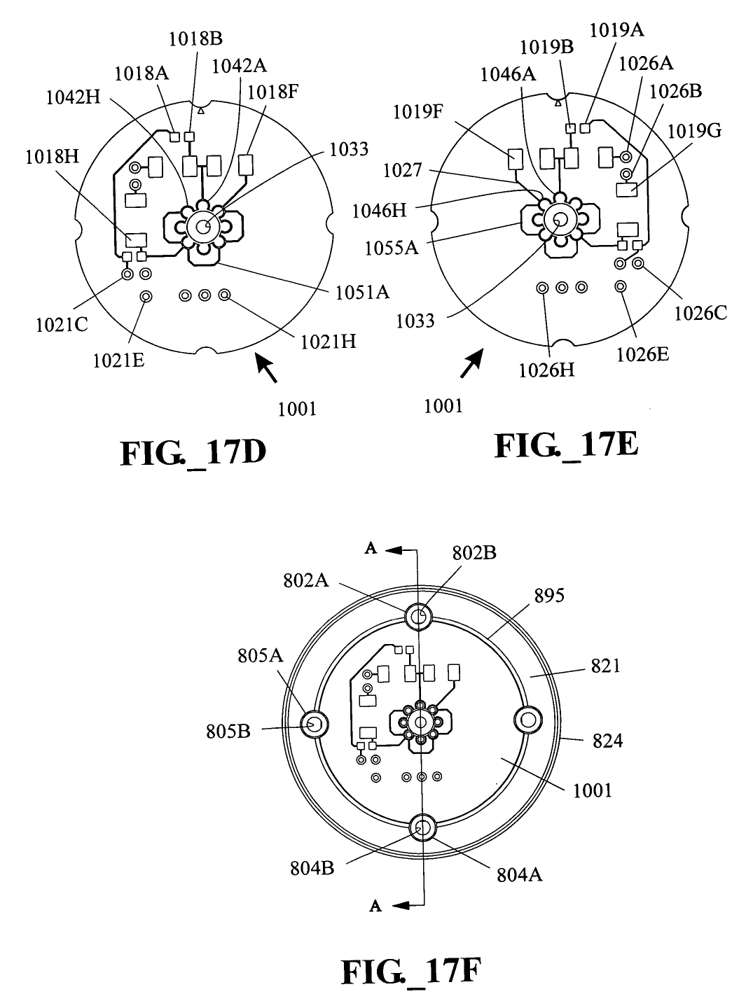

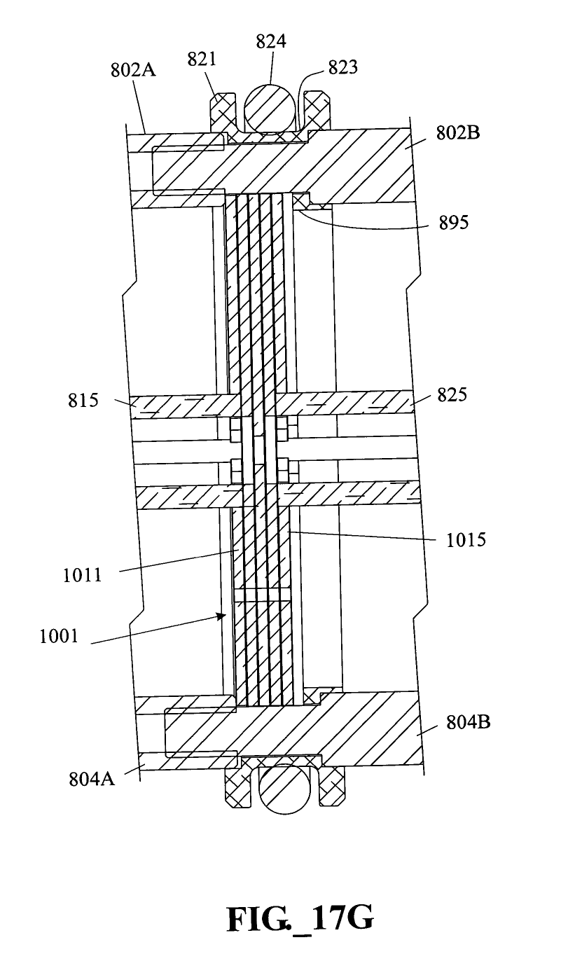

Each ion transfer optic element 810, 820, 830 is preferably supported by multiple longitudinal structural supports 802-805 protruding from a flange 809 disposed adjacent to the mass analyzer section 850. Each longitudinal support 802-805 is preferably composed of multiple sections 802A-802C, 803A-803C, 804A-804C, 805A-805C joined to one another, or more preferably joined by way of the rim members 821, 831, using any suitable method such as threaded engagement. While a single support such as a perforated pipe might alternatively be used, the use of multiple discrete longitudinal supports 802-805 is preferred to provide ventilation utility (to permit migration of neutrals between supports and away from the module in the direction of an appropriate vacuum pumping element), facilitate alignment between ion transfer optic elements 810, 820, 830, and to impart axial and lateral stiffness to the various components associated with the ion transfer optic elements 810, 820, 830, all at an economical cost. Each longitudinal support 802-805, which may be fabricated from metallic round bar stock, supports two rim members 821, 831, a skimmer support 811, and four intermediate spacer elements 818, 819, 828, 829. Each rim member 821, 831 and the skimmer support, which are preferably annular in shape, defines an outer peripheral groove (e.g., grooves 823, 824) adapted to hold an O-ring or equivalent sealing element (e.g., O-ring 814) for providing sealing utility between adjacent vacuum regions 941-944 (as illustrated in FIG. 16D) defined by the module(s) 800 and a vacuum enclosure 900. Each spacer element 818, 819, 828, 829 further defines one or more apertures (e.g., apertures 817) therein to permit wires or equivalent conductors (not shown) to be routed longitudinally within each ion transfer optic element 810, 820, 830. Each spacer element 818, 819, 828, 829 also defines multiple mechanical capture regions (similar to the capture regions 1041A-1041H, 1045A-1045H illustrated in FIGS. 17A-17F but lacking electrical conductors) for physically retaining the poles 815 in position disposed equidistantly around the axis of ion travel through the ion transfer optic assembly 801.

Along the entry to the first ion transfer optic element 810, the skimmer support 811 supports a central skimmer cone 812 having a central aperture (not shown) disposed along the axis of the ion beam. The skimmer cone 812, which preferably comprises an electrically conductive material (e.g., a metal such as aluminum), serves to reduce the number of ions entering the ion transfer optic assembly 810 while providing a reasonably narrow ion beam. Voltage is supplied to the skimmer cone 812 by wires or equivalent conductors (not shown) that extend longitudinally through the first ion transfer optic element 810 and are routed through apertures (e.g., 817) defined in two spacer elements 818, 819. The skimmer support 811 is preferably fabricated from a vacuum compatible electrically insulating material such as poly (ether ether ketone) (“PEEK”). The first rim member 821 supports a first multi-layer hub 1001. In an alternative embodiment, the functions of the first rim 821 and first hub 1001 (or second rim 831 and second hub 1101) may be integrated into a single combined member (not shown). Multiple electrically conductive poles 815 extend longitudinally through the first ion transfer optic element 810 between the skimmer cone 812 and the first hub 1001. Each pole 815 should be electrically isolated from the skimmer cone 812, such as by maintaining physical separation between the poles 815 and the skimmer cone 812. At the opposite end of the ion transfer optic element 810, however, each pole 815 is in electrical (conductive) communication with the first multi-layer hub 1001. The first hub 1001 serves multiple functions, including providing mechanical support for poles 815, 825, conveying and/or distributing electrical signals among components within individual vacuum regions 941, 942 and between vacuum regions 941, 942, and serving as a conductance limit to permit passage of ions yet facilitate the maintenance of differential pressure conditions between adjacent vacuum regions 941, 942.

More detailed views of the first multi-layer hub 1001 are provided in FIGS. 17A-17E. The hub 1001, which is disposed between the first ion transfer optic element 810 and the second ion transfer optic element 820, is preferably fabricated from multiple substrates 1011-1015 each comprising conventional printed circuit board materials such as FR-4. Five substrates 1011-1015 are shown, with the outer substrates 1011, 1015 and central substrate 1013 having copper layers disposed on at least portions of both sides thereof. The remaining intermediate substrates 1012, 1014 serve as insulating connecting layers and each have a bonding agent such as an epoxy deposited on both sides thereof. Each substrate 1011-1015 defines a central aperture 1031-1035 through which ions are directed, along with several peripheral apertures 1020A-1020H through which wires or equivalent conductors (not shown) are inserted and soldered into place.

The outer substrates 1011, 1015 of the hub 1001 define arcuate pole capture regions 1041A-1041H, 1045A-1045H distributed around the circumference of the central apertures 1031, 1035, with the hub 1001 being in electrical communication with two sets of poles 815, 825. Note that each spacer element 818, 819, 828, 829 (described previously) preferably has similar capture regions (not shown). To provide adequate mechanical retention (capture) utility, each pole capture region 1041A-1041H, 1045A-1045H should have an arc angle of at least about 200 degrees, more preferably at least about 210 degrees, more preferably still at least about 220 degrees, and even more preferably at least about 240 degrees. In one embodiment, each capture region 1041A-1041H, 1045A-1045H has an arc angle of about 265 degrees. There is a practical upper limit to the arc angle of each capture region 1041A-1041H, 1045A-1045H, however, since the inner surface of each pole 815, 825 closest to the ion path axis should be unobstructed so as not to interfere with the electric field generated by the poles 815.

As shown in FIGS. 17A-17E, each capture region 1041A-1041H, 1045A-1045H is bordered along the outer layers 1011, 1015 by conductive (e.g., copper) materials such as in the form of surface traces 1042A-1042H. Additionally, each peripheral aperture 1020A-1020H defined in the outer substrates 1011, 1015 is surrounded by a similar conductive material (e.g., surface trace) 1020A-1020H.

After the various hub layers 1011-1015 are joined to form the hub 1001, wires or equivalent conductors (not shown) are inserted into each peripheral aperture 1020A-1020H and soldered or otherwise conductively affixed into place (e.g., using a vacuum compatible conductive epoxy). In addition to facilitating electrical communication, the solder or epoxy also serves to seal each peripheral aperture 1020A-1020H, thus preventing undesirable gas leakage between adjacent vacuum regions 942-943. Each pole 815, 825 is inserted into a different capture region 1041A-1041H, 1045A-1045H to abut an insulating layer 1012, 1014 that serves as a travel stop for the poles 815, 825. Thereafter, each pole 815, 825 is preferably joined to a different capture region surface trace 1042A-1042H, 1046A-1046H by way of an electrically conductive connection such as solder or conductive epoxy to ensure reliable electrical connection and enhance mechanical retention. Common electrical signals are provided to each subset (e.g., four in number) of alternating poles 815, 825 by way of conductive “jumper” traces defined on the front and back sides 1011A, 1011B, 1015A, 1015B of the outer substrates. Additionally, multiple conductive pads 1018A-1018J, 1019A-1019J are defined on the outward surfaces 1011A, 1015B of the finished device to permit the addition (e.g., by soldering) of capacitors or other desirable circuit components.

Referring to FIG. 17B, the central substrate layer 1013 defines a central aperture 1033 that serves as a conductance limit. The central layer 1013 surrounding the conductance limit 1033 serves as a portion of the boundary between adjacent vacuum regions 942-943, with the conductance limit 1033 being intended to permit the passage of ions from adjacent vacuum regions 942-943 while facilitating a differential pressure of approximately two orders of magnitude to be maintained therebetween. In one embodiment, the conductance limit 1033 defined in the first hub 1001 has an internal diameter of about 1.5 to 2 mm. Voltage is supplied to conductance limit by way of one or more wires (not shown) soldered into the peripheral apertures 1021A-1021H, 1026A-1026H and by way of copper plating disposed on both surfaces of the central substrate 1013 and through the central aperture 1033. Additional plating of a corrosion-resistant material such as gold should be applied over the copper plating immediately adjacent to the conductance limit 1033.

Additional views of the hub 1001, showing its position relative to the support element sections 802A-805A, 802B-805B and the surrounding first rim 821, are provided in FIGS. 17F-17G. Each second ion transfer optic region support element section 802B-805B has a threaded male end that is inserted through apertures defined in the first rim 821 and into corresponding tapped recesses defined in corresponding first ion transfer optic region support element section 802A-805A. The hub 1001 is retained within the first rim 821 by compressive action of the second ion transfer optic region support element sections 802B-805B, with sealing between the first hub 1001 and first rim 821 promoted by a gasket 895 disposed along the inner surface of the first rim 821. Along the outer periphery of the first rim 821, a groove 823 retains an O-ring or equivalent sealing element 824 that is intended to mate with a sealing surface of a surrounding enclosure 900 to prevent leakage between adjacent vacuum regions 942, 943. Each pole 815, 825 is further retained by the first hub 1001 against insulating layers 1012, 1014 by way of capture regions 1041A-1041H, 1045A-1045H.

Referring back to FIGS. 15A-15C, the second ion transfer optic element 820 is bounded at one end by the first rim 1001 and hub 821, and at the other end by the second rim 1101 and hub 831 substantially identical to the first rim 1001 and hub 821. The primary distinction between the second ion transfer optic element 820 and the first ion transfer optic element 810 is the intended operating pressure. Ions are conducted from the first hub 821 between the second set of poles 825 and through the second hub 831.

The third ion transfer optic element 830 is shorter than the preceding first and second ion transfer optic elements 810, 820 and lacks any spacer elements (e.g., compared to spacers 818, 819, 828, 829). In operation, the third ion transfer optic element 830 is disposed within the same vacuum region 944 as the mass analyzer section 850, and is thus subject to substantially the same operating pressure conditions. The third ion transfer optic element 830 includes another set of poles 835 disposed between the second rim 1101 and a mating flange 809 joined to the mass analyzer support frame 868.

Just downstream of the third ion transfer optic element 830 in the path of an ion beam, the mass analyzer section 850 includes an ion optic focusing element 851, which may include a beam collimator or Einzel lens. The ion beam is then directed to an ion accelerator 852 that includes multiple aperture-defining charged plates 853. Ions are directed by the accelerator 852 into the flight chamber 860 bounded by multiple walls 861-864, 866, which preferably include conductive materials to which a charge is applied to generate a field-free region so as not to interfere with the path of ions within the chamber 860. The flight chamber 860 further includes an ion mirror or reflectron 855 that includes multiple reflector elements 856-859. Each reflector element 856-859 preferably includes a high transmission metallic screen (not shown) disposed across the flight chamber 860. Each reflector element 856-859 corresponds to a different plate 853 of the ion accelerator 852 and reflects ions toward an ion detector/transducer 854, which preferably comprises a microchannel plate or a discrete dynode. Opposing the reflectron 855 and ion accelerator 853 adjacent to the distal reflector element 859, the chamber wall 865 preferably defines multiple apertures or slots to permit migration of neutral species (which are unaffected to the ion accelerator 852 and the reflectron 855) away from the flight chamber 860.

The mass analyzer support frame 868 is joined to a back panel 870 through which the feed through interface 880 protrudes. The back panel 870 includes a raised surface 872 that retains at least one O-ring, gasket, or equivalent sealing element 874 to promote sealing and prevent leakage from the atmosphere into the fourth vacuum region 944.

While a single module 800 has been described and illustrated in FIGS. 15A-15C, a common vacuum enclosure is intended to contain multiple modules. As shown in FIGS. 16A-16D, in one embodiment, a modular mass spectrometer 1000 includes an enclosure 900 adapted to contain twelve modules 800A-800X. As will be recognized by one skilled in the art, a larger or smaller number of modules could be provided. For the sake of clarity, only a first module 800A (identical to the module 800 described in connection with FIGS. 15A-15C) is shown in FIGS. 16A-16D, with each element of the module 800A denoted with an “A”. For example, the first module 800A includes an ion optic transfer assembly 801A including three ion transfer optic elements 810A, 820A, 830A leading to a mass analyzer section 850A. The mass analyzer section 850A includes an ion accelerator 852A and an ion mirror or reflectron 855A. The module 800A includes a back panel 870A and a feed through interface 880A. The corresponding elements of a second module 800B (not shown but identical to the first module 800A) would include the same element numbers each punctuated with a “B,” and so on with elements of a third module 800C and fourth module 800D each punctuated with a “C” and “D,” respectively, up to an arbitrary last module 800X having individual module elements each punctuated with an “X.” Hereinafter, the group of modules (each identical to the module 800 as described previously) will be referred to as modules 800A-800X, with the individual module element numbers punctuated with letters A-X, respectively.

The first module 800A has an associated ionization source 981A, ion emitter 982A, and a sample inlet conduit 984A, with each module 800A-800X preferably having identical associated components (e.g., an ionization source 981A-981X, a sample inlet conduit 984A-984X, and an ion emitter 982A-982X, respectively). In an alternative embodiment (not shown), the outputs of one or more ionization sources may be multiplexed (switched) to multiple modules. In a preferred embodiment, electrospray ionization is employed.

The enclosure 900 has a general “L-shaped” configuration and includes multiple external walls 902-908. Each wall 902-908 preferably comprises rigid materials suitable for withstanding a differential pressure of at least one atmosphere. Suitable wall materials may include aluminum or stainless steel. To promote sealing, the walls 902-908 are preferably joined by welding. A front wall 901 defines multiple apertures 930A-930X that permit interface with the ionization sources 981A-981X. A rear wall 903 defines multiple apertures 935A-935X that permit the insertion of modules 880A-880X into, and removal of modules 880A-880X from, the enclosure 900. Enclosure stiffening members 939A-939E are preferably provided to provide structural support to the enclosure 900.

The upper wall 907 defines three access apertures 911-913 that are sealed with mating panels (not shown) following fabrication of the instrument 1000. Three turbo pumps 931-933 are provided in fluid communication with the second through fourth vacuum regions 942-944, respectively, disposed within the enclosure 900. An additional, larger vacuum pump 934 in fluid communication with the first vacuum region 941 by way of a first port 921 and a hose connection (not shown) is preferably disposed below the enclosure 900. The enclosure 900 further defines a first stage vacuum port 921 that permits fluid communication with an external first stage “roughing” vacuum pump 934, and defines additional ports 922-927 that permit the monitoring of conditions (e.g., pressures) within the various vacuum regions 941-944 and/or permit cascading operation of the vacuum pumps 931-934. A lower support member 990 provides structural support for the enclosure 900, which may be mounted atop a table or mobile cart (not shown).

Within the enclosure 900, interior partition walls 950, 960, 970 (together comprising a chassis 945) are disposed along the boundaries between the first through fourth vacuum regions 941-944. The interior partitions 950, 960, 970 are preferably joined to the surrounding walls 902, 906, 907, 908 by welding, casting, or an equivalent joining method. The first partition 950 defines multiple (e.g., twelve) apertures 951A-951X each designed to mate along a sealing surface 952A-952X with the O-ring or equivalent sealing element 814A-814X adjacent to the skimmer support 811 of each module 800A-800X. Similarly, the second partition 960 defines multiple apertures 961A-961X each designed to mate along a sealing surface 962A-962X with an O-ring 824A-824X (disposed in the groove 823A-823X) associated with the first rim 821A-821X of each module 800A-800X. Likewise, the third partition 970 defines multiple apertures 971A-971X each designed to mate along a sealing surface 972A-972X with an O-ring 834A-834X (disposed in the groove 833A-833X) associated with the second rim 831A-831X of each module 800A-800X. Thus, in other words, the modules 800A-800X mate with the partitions 950, 960, 970 to define the boundaries between the first and second vacuum regions 941, 942, between the second and third vacuum regions 942, 943, and between the third and fourth vacuum regions 943, 944.

The O-ring 874A-874X associated with the back plate 870A-870X of each module 800A-800X mates with the corresponding boundaries of the apertures 935A-935X defined in the rear wall 903 of the enclosure 900 to provide a pressure-tight seal. With each module 800A-800X disposed within the enclosure 900, electrical communication with the modules 800A-800X is provided by way of the external feed through interfaces 880A-880X. In a preferred embodiment, each feed through interface 880A-880X comprises a printed circuit board with at least one multi-conductor connection such as a plug receptacle and/or edge connector region.

In operation of the modular mass spectrometer 1000, multiple sample streams from multiple fluid phase separation regions (e.g., the regions 439A-439X disposed within a multi-column microfluidic separation device 400 as described previously) are preferably supplied simultaneously to multiple modules 800A-800X. For each module, a sample stream is ionized using an electrospray ionization source 981A-981X and an emitter 982A-982X and injected into a sample inlet conduit 984A-984X extending through an aperture 930A-930X defined in an outer wall 901 of the enclosure 900. Each sample inlet conduit 984A-984X is disposed in the first vacuum region 941, which is preferably maintained at a pressure of about one torr (101 kPa). Each sample inlet conduit 984A984X directs ion-containing gas to a skimmer 812A-812X that serves to aerodynamically focus the ions into a first ion transfer optic element 810A-810X. The first ion transfer optic element 810A-810X of each module 800A-800X is disposed within the second vacuum region 942, which is preferably maintained at a pressure of between about 5×10−2 to 1×10−3 torr (6.7 to 0.13 Pa). Within the first ion transfer optic element 810A-810X of each module 800A-800X, some neutral species preferably migrate between poles 815A-815X away from the path of the ion beam. As the ion beam exits the first ion transfer optic element 810A-810X through the first conductance limit 1033A-1033X defined in the hub 1001A-1001X, it enters the second ion transfer optic element 820A-820X disposed within the third vacuum region 943. The third vacuum region 943 is preferably maintained at a pressure of between about 5×10−4 to 1×10−5 torr (6.7×10−2 to 1.3×10−3 Pa). Within the second ion transfer optic element 820A-820X, additional neutral species preferably migrate between poles 825A-825X away from the path of the ion beam. As the ion beam exits the second ion transfer optic element 820A-820X through a second conductance limit (not shown) defined in the second hub 1101A-1101X, it enters the third ion transfer optic element 830A-830X disposed within the fourth vacuum region 944. The fourth vacuum region 944 is preferably maintained at a pressure of about 1×10″6 torr (1.3×10−4 Pa). Within each module 800A-800X, the third ion transfer optic element 830A-830X directs ions to the ion accelerator 852A-852X. Ions are directed by the accelerator 852A-852X into the flight chamber 860A-860X. Within the flight chamber, the reflectron or ion mirror 855A-855X reflects ions toward a detector/transducer 854A-854X, where ions are detected. For each module 800A-800X, output signals from the transducer 854A-854X are transmitted through the feed through interface 880A-800X to an external controller/processor device (not shown) for further processing, storage, and/or display. In this manner, multiple samples may be analyzed in parallel, utilizing a fluid phase separation process followed by mass spectrometric analysis, with no cross-talk between adjacent analyzer channels.

A method for analyzing multiple samples in parallel using the foregoing devices and/or systems devices includes several method steps. A first method step includes providing at least one ionization source. A second method step includes providing a mass spectrometer having multiple modules in fluid communication with the ionization source(s), with each module being disposed within a common enclosure having at least one vacuum region, being adapted to operate in parallel, having an associated ion transfer optic element, and having an associated mass analyzer, with the ion transfer optic element further being disposed within the (at least one) vacuum region. A third method step includes providing multiple prepared samples. The prepared samples may be obtained by performing a fluid phase separation process on raw samples. A fourth method step includes ionizing at least a portion of each prepared sample with the ionization source(s) to yield multiple gaseous streams each including an ionized species and a non-ionized species. A fifth method step includes directing each gaseous stream into a different module. A sixth method step includes, for each module, directing at least a portion of the ionized species through the associated ion transfer optic element to the associated mass analyzer. A seventh method step includes, for each module, detecting at least a subset of the at least a portion of the ionized species using the associated mass analyzer. In a preferred embodiment, the at least one ionization source includes multiple ionization sources, and each module is associated with a different ionization source.

High throughput analytical systems and methods according to various embodiments of the present invention provide numerous benefits. For example, continuous output streams from multiple fluid phase separation process regions may be analyzed in parallel by different mass analyzers, thus permitting high throughput operation without the data loss problems typically created by sampling methods. Moreover, because each analyzer of a multi-analyzer mass spectrometer may be disposed within a common vacuum enclosure, fewer vacuum pumps may be required to provide the necessary vacuum conditions. Modular construction provides numerous advantages including more efficient fabrication along with ease of maintenance and servicing. Additionally, control functions and components may be consolidated. The use of common control components not only simplifies fabrication, but also ensures consistent operation from one mass analyzer to the next.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A multi-channel mass spectrometer comprising:
a vacuum enclosure having a plurality of sample inlets;
a plurality of common vacuum pumping elements;
at least one ionization source in fluid communication with the plurality of sample inlets; and
a plurality of modules disposed substantially within the vacuum enclosure and adapted to operate in parallel, each module of the plurality of modules being in fluid communication with a different sample inlet of the plurality of sample inlets and having:
at least one ion transfer optic element; and
a mass analyzer including a transducer;
wherein the plurality of modules mate with the vacuum enclosure to define a plurality of sequential vacuum regions, with each vacuum region of the plurality of sequential vacuum regions having at least one associated common vacuum pumping element of the plurality of common vacuum pumping elements.

2. The mass spectrometer of claim 1 wherein the vacuum enclosure includes an internal chassis.

3. The mass spectrometer of claim 1 wherein the at least one ionization source includes a plurality of ionization sources, and each ionization source of the plurality of ionization sources is in fluid communication with a different sample inlet of the plurality of sample inlets.

4. The mass spectrometer of claim 1 of the preceding claims wherein the at least one ionization source comprises at least one electrospray ionization source.

5. The mass spectrometer of claim 1 wherein each vacuum region of the plurality of vacuum regions is maintained at a different absolute pressure by a different common vacuum pumping element of the plurality of common vacuum pumping elements.

6. The mass spectrometer of claim 1, further comprising a common voltage source, wherein at least two modules of the plurality of modules are in electrical communication with the common voltage source.

7. The mass spectrometer of claim 1 wherein the mass analyzer comprises any of a time-of-flight mass analyzer, a quadrupole mass analyzer, and an ion trap mass analyzer.

8. The mass spectrometer of claim 1 wherein each module comprises a selectively dischargeable ion trap.

9. The mass spectrometer of claim 1 wherein the at least one ion transfer optic element comprises a multi-pole ion optic element.

10. The mass spectrometer of claim 1 wherein the mass analyzer further includes an ion optic focusing element, an ion accelerator, and a flight chamber.

11. The mass spectrometer of claim 10 wherein the mass analyzer further includes a reflectron.

12. The mass spectrometer of claim 1 wherein each module of the plurality of modules includes an electrical interface at least partially disposed outside the vacuum enclosure.

13. The mass spectrometer of claim 1 wherein the plurality of vacuum regions includes at least three vacuum regions, and the plurality of common vacuum pumping elements comprises at least three common vacuum pumping elements.

14. The mass spectrometer of claim 1 wherein the plurality of modules mate with the vacuum enclosure along a plurality of mating surfaces, the spectrometer further comprising a plurality of sealing elements associated with the plurality of sealing surfaces, the plurality of sealing elements being adapted to prevent fluid communication between adjacent vacuum regions of the plurality of sequential vacuum regions along the plurality of mating surfaces.

15. The mass spectrometer of claim 1, further comprising a processor in electrical communication with the transducer.

16. An analytical system comprising:
the mass spectrometer of any of the preceding claims; and
a plurality of fluid phase separation process regions;
wherein each fluid phase separation process region of the plurality of fluid phase separation process regions is in fluid communication with the at least one ionization source.

17. The analytical system of claim 16 wherein each fluid phase separation process region the plurality of fluid phase separation process regions is microfluidic.

18. The analytical system of claim 16 wherein each fluid phase separation process region of the plurality of fluid phase separation process regions is disposed within a unitary device.

19. The analytical system of claim 16 wherein each fluid phase separation process region of the plurality of fluid phase separation process regions comprises a liquid chromatography column.

20. The analytical system of claim 16, further comprising a flow-through detection subsystem disposed between the plurality of fluid phase separation process regions and the mass spectrometer, wherein the flow-through detection subsystem includes a radiation source, a plurality of flow cells, and a plurality of optical detectors.

21. The analytical system of claim 16 wherein the number of modules equals the number of fluid phase separation process regions.

22. A method for analyzing a plurality of samples in parallel, the method comprising the steps of:
providing at least one ionization source;
providing a mass spectrometer having a plurality of modules in fluid communication with the at least one ionization source, each module of the plurality of modules being disposed within a common enclosure having at least one vacuum region, being adapted to operate in parallel, having an associated ion transfer optic element, and having an associated mass analyzer, the ion transfer optic element being disposed within the at least one vacuum region;
providing a plurality of prepared samples;
ionizing at least a portion of each prepared sample with the at least one ionization source to yield a plurality of gaseous streams, each gaseous stream of the plurality of gaseous streams including an ionized species and a non-ionized species;
directing each gaseous stream of the plurality of gaseous streams into a different module of the plurality of modules, such that each module of the plurality of modules has an associated gaseous stream of the plurality of gaseous streams;
for each module of the plurality of modules, directing at least a portion of the ionized species through the associated ion transfer optic element to the associated mass analyzer; and
for each module of the plurality of modules, detecting at least a subset of the at least a portion of the ionized species using the associated mass analyzer.

23. The method of claim 22, further comprising the steps of:
providing a plurality of fluid phase separation process regions in fluid communication with the at least one ionization source;
supplying a plurality of raw samples to the plurality of fluid phase separation process regions; and
performing a fluid phase separation process on the plurality of samples in the plurality of fluid phase separation process regions to yield a plurality of prepared samples.

24. The method of claim 22 wherein the at least one ionization source comprises a plurality of ionization sources, and each module of the plurality of modules is associated with a different ionization source of the plurality of ionization sources.
